(19) United States
(12) Patent Application Publication
(10) Pub. No.: US 2004/0032462 A1
(43) Pub. Date: Feb. 19, 2004

(54) Inkjet printhead nozzle with ribbed wall actuator

(75) Inventors: Kia Silverbrook, Balmain (AU); Gregory John McAvoy, Balmain (AU)

Correspondence Address: SILVERBROOK RESEARCH PTY LTD, 393 DARLING STREET, BALMAIN, 2041, AU

(73) Assignee: SILVERBROOK RESEARCH PTY LTD

(21) Appl. No.: 10/636,278

(22) Filed: Aug. 8, 2003

Related U.S. Application Data
(63) Continuation of application No. 09/854,703, filed on May 14, 2001, now abandoned.
Application No. 09/854,703 is a continuation of application No. 09/112,806, filed on Jul. 10, 1998, now Pat. No. 6,247,790.

(30) Foreign Application Priority Data
Jun. 8, 1998 (AU) PP3987

(51) Int. Cl. B41J 2/04

(52) U.S. Cl. 347/54

(57) ABSTRACT

An ink jet printhead nozzle arrangement having an ink chamber formed in a wafer substrate and one wall of said chamber having at least one flexible portion. The ink ejection port is formed substantially centrally on the wall with a rim surrounding it. The wall is adapted to move independently of said rim. Rib elements are located on the outer surface of the wall to restrict the wall movement such that upon actuation of the at least one flexible portion of the wall, the wall is forced to move into said ink chamber, forcing ink therein out through the said ejection port.

This is a Continuation application U.S. Ser. No. 09/854,703 filed May 14, 2001

### CROSS REFERENCES TO RELATED APPLICATIONS

This application is a continuation application of our co-pending application Ser. No. 09/112,806 filed Jul. 10, 1998 and which has been allowed. The disclosure of U.S. Ser. No. 09/112,806 is specifically incorporated herein by reference.

The following Australian provisional patent applications are hereby incorporated by cross-reference. For the purposes of location and identification, U.S. patent applications identified by their U.S. patent application serial numbers (USSN) are listed alongside the Australian applications from which the U.S. patent applications claim the right of priority.

| | US PATENT/PATENT | |
|---|---|---|
| | APPLICATION | |
| | (CLAIMING RIGHT OF | |
| CROSS-REFERENCED | PRIORITY FROM | |
| AUSTRALIAN | AUSTRALIAN | |
| PROVISIONAL PATENT | PROVISIONAL | |
| APPLICATION NO. | APPLICATION) | DOCKET NO. |
| PO7991 | 09/113,060 | ART01 |
| PO8505 | 09/113,070 | ART02 |
| PO7988 | 09/113,073 | ART03 |
| PO9395 | 09/112,748 | ART04 |
| PO8017 | 09/112,747 | ART06 |
| PO8014 | 09/112,776 | ART07 |
| PO8025 | 09/112,750 | ART08 |
| PO8032 | 09/112,746 | ART09 |
| PO7999 | 09/112,743 | ART10 |
| PO7998 | 09/112,742 | ART11 |
| PO8031 | 09/112,741 | ART12 |
| PO8030 | 09/112,740 | ART13 |
| PO7997 | 09/112,739 | ART15 |
| PO7979 | 09/113,053 | ART16 |
| PO8015 | 09/112,738 | ART17 |
| PO7978 | 09/113,067 | ART18 |
| PO7982 | 09/113,063 | ART19 |
| PO7989 | 09/113,069 | ART20 |
| PO8019 | 09/112,744 | ART21 |
| PO7980 | 09/113,058 | ART22 |
| PO8018 | 09/112,777 | ART24 |
| PO7938 | 09/113,224 | ART25 |
| PO8016 | 09/112,804 | ART26 |
| PO8024 | 09/112,805 | ART27 |
| PO7940 | 09/113,072 | ART28 |
| PO7939 | 09/112,785 | ART29 |
| PO8501 | 09/112,797 | ART30 |
| PO8500 | 09/112,796 | ART31 |
| PO7987 | 09/113,071 | ART32 |
| PO8022 | 09/112,824 | ART33 |
| PO8497 | 09/113,090 | ART34 |
| PO8020 | 09/112,823 | ART38 |
| PO8023 | 09/113,222 | ART39 |
| PO8504 | 09/112,786 | ART42 |
| PO8000 | 09/113,051 | ART43 |
| PO7977 | 09/112,782 | ART44 |
| PO7934 | 09/113,056 | ART45 |
| PO7990 | 09/113,059 | ART46 |
| PO8499 | 09/113,091 | ART47 |
| PO8502 | 09/112,753 | ART48 |
| PO7981 | 09/113,055 | ART50 |
| PO7986 | 09/113,057 | ART51 |
| PO7983 | 09/113,054 | ART52 |
| PO8026 | 09/112,752 | ART53 |
| PO8027 | 09/112,759 | ART54 |
| PO8028 | 09/112,757 | ART56 |
| PO9394 | 09/112,758 | ART57 |
| PO9396 | 09/113,107 | ART58 |
| PO9397 | 09/112,829 | ART59 |
| PO9398 | 09/112,792 | ART60 |
| PO9399 | 6,106,147 | ART61 |
| PO9400 | 09/112,790 | ART62 |
| PO9401 | 09/112,789 | ART63 |
| PO9402 | 09/112,788 | ART64 |
| PO9403 | 09/112,795 | ART65 |
| PO9405 | 09/112,749 | ART66 |
| PP0959 | 09/112,784 | ART68 |
| PP1397 | 09/112,783 | ART69 |
| PP2370 | 09/112,781 | DOT01 |
| PP2371 | 09/113,052 | DOT02 |
| PO8003 | 09/112,834 | Fluid01 |
| PO8005 | 09/113,103 | Fluid02 |
| PO9404 | 09/113,101 | Fluid03 |
| PO8066 | 09/112,751 | IJ01 |
| PO8072 | 09/112,787 | IJ02 |
| PO8040 | 09/112,802 | IJ03 |
| PO8071 | 09/112,803 | IJ04 |
| PO8047 | 09/113,097 | IJ05 |
| PO8035 | 09/113,099 | IJ06 |
| PO8044 | 09/113,084 | IJ07 |
| PO8063 | 09/113,066 | IJ08 |
| PO8057 | 09/112,778 | IJ09 |
| PO8056 | 09/112,779 | IJ10 |
| PO8069 | 09/113,077 | IJ11 |
| PO8049 | 09/113,061 | IJ12 |
| PO8036 | 09/112,818 | IJ13 |
| PO8048 | 09/112,816 | IJ14 |
| PO8070 | 09/112,772 | IJ15 |
| PO8067 | 09/112,819 | IJ16 |
| PO8001 | 09/112,815 | IJ17 |
| PO8038 | 09/113,096 | IJ18 |
| PO8033 | 09/113,068 | IJ19 |
| PO8002 | 09/113,095 | IJ20 |
| PO8068 | 09/112,808 | IJ21 |
| PO8062 | 09/112,809 | IJ22 |
| PO8034 | 09/112,780 | IJ23 |
| PO8039 | 09/113,083 | IJ24 |
| PO8041 | 09/113,121 | IJ25 |
| PO8004 | 09/113,122 | IJ26 |
| PO8037 | 09/112,793 | IJ27 |
| PO8043 | 09/112,794 | IJ28 |
| PO8042 | 09/113,128 | IJ29 |
| PO8064 | 09/113,127 | IJ30 |
| PO9389 | 09/112,756 | IJ31 |
| PO9391 | 09/112,755 | IJ32 |
| PP0888 | 09/112,754 | IJ33 |
| PP0891 | 09/112,811 | IJ34 |
| PP0890 | 09/112,812 | IJ35 |
| PP0873 | 09/112,813 | IJ36 |
| PP0993 | 09/112,814 | IJ37 |
| PP0890 | 09/112,764 | IJ38 |
| PP1398 | 09/112,765 | IJ39 |
| PP2592 | 09/112,767 | IJ40 |
| PP2593 | 09/112,768 | IJ41 |
| PP3991 | 09/112,807 | IJ42 |
| PP3987 | 09/112,806 | IJ43 |
| PP3985 | 09/112,820 | IJ44 |
| PP3983 | 09/112,821 | IJ45 |
| PO7935 | 09/112,822 | IJM01 |
| PO7936 | 09/112,825 | IJM02 |
| PO7937 | 09/112,826 | IJM03 |
| PO8061 | 09/112,827 | IJM04 |
| PO8054 | 09/112,828 | IJM05 |
| PO8065 | 6,071,750 | IJM06 |
| PO8055 | 09/113,108 | IJM07 |
| PO8053 | 09/113,109 | IJM08 |
| PO8078 | 09/113,123 | IJM09 |
| PO7933 | 09/113,114 | IJM10 |
| PO7950 | 09/113,115 | IJM11 |
| PO7949 | 09/113,129 | IJM12 |
| PO8060 | 09/113,124 | IJM13 |
| PO8059 | 09/113,125 | IJM14 |
| PO8073 | 09/113,126 | IJM15 |
| PO8076 | 09/113,119 | IJM16 |
| PO8075 | 09/113,120 | IJM17 |
| PO8079 | 09/113,221 | IJM18 |
| PO8050 | 09/113,116 | IJM19 |
| PO8052 | 09/113,118 | IJM20 |
| PO7948 | 09/113,117 | IJM21 |
| PO7951 | 09/113,113 | IJM22 |
| PO8074 | 09/113,130 | IJM23 |
| PO7941 | 09/113,110 | IJM24 |
| PO8077 | 09/113,112 | IJM25 |
| PO8058 | 09/113,087 | IJM26 |
| PO8051 | 09/113,074 | IJM27 |
| PO8045 | 6,111,754 | IJM28 |
| PO7952 | 09/113,088 | IJM29 |
| PO8046 | 09/112,771 | IJM30 |
| PO9390 | 09/112,769 | IJM31 |
| PO9392 | 09/112,770 | IJM32 |
| PP0889 | 09/112,798 | IJM35 |
| PP0887 | 09/112,801 | IJM36 |
| PP0882 | 09/112,800 | IJM37 |
| PP0874 | 09/112,799 | IJM38 |
| PP1396 | 09/113,098 | IJM39 |
| PP3989 | 09/112,833 | IJM40 |
| PP2591 | 09/112,832 | IJM41 |
| PP3990 | 09/112,831 | IJM42 |
| PP3986 | 09/112,830 | IJM43 |
| PP3984 | 09/112,836 | IJM44 |
| PP3982 | 09/112,835 | IJM45 |
| PP0895 | 09/113,102 | IR01 |
| PP0870 | 09/113,106 | IR02 |
| PP0869 | 09/113,105 | IR04 |
| PP0887 | 09/113,104 | IR05 |
| PP0885 | 09/112,810 | IR06 |
| PP0884 | 09/112,766 | IR10 |
| PP0886 | 09/113,085 | IR12 |
| PP0871 | 09/113,086 | IR13 |
| PP0876 | 09/113,094 | IR14 |
| PP0877 | 09/112,760 | IR16 |
| PP0878 | 09/112,773 | IR17 |
| PP0879 | 09/112,774 | IR18 |
| PP0883 | 09/112,775 | IR19 |
| PP0880 | 09/112,745 | IR20 |
| PP0881 | 09/113,092 | IR21 |
| PO8006 | 6,087,638 | MEMS02 |
| PO8007 | 09/113,093 | MEMS03 |
| PO8008 | 09/113,062 | MEMS04 |
| PO8010 | 6,041,600 | MEMS05 |
| PO8011 | 09/113,082 | MEMS06 |
| PO7947 | 6,067,797 | MEMS07 |
| PO7944 | 09/113,080 | MEMS09 |
| PO7946 | 6,044,646 | MEMS10 |
| PO9393 | 09/113,065 | MEMS11 |
| PP0875 | 09/113,078 | MEMS12 |
| PP0894 | 09/113,075 | MEMS13 |

### STATEMENT REGARDING FEDERALLY SPONSORED RESEARCH OR DEVELOPMENT

Not applicable.

1. Field of the Invention

The present invention relates to the field of inkjet printing and, in particular, discloses an inverted radial back-curling thermoelastic ink jet printing mechanism.

2. Background of the Invention

Many different types of printing mechanisms have been invented, a large number of which are presently in use. The known forms of printers have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years the field of ink jet printing, wherein each individual pixel of ink is derived from one or more ink nozzles, has become increasingly popular primarily due to its inexpensive and versatile nature.

Many different techniques of inkjet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different forms. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous ink jet printing including a step wherein the ink jet stream is modulated by a high frequency electro-static field so as to cause drop separation. This technique is still utilized by several manufacturers including Elmjet and Scitex (see also U.S. Pat. No. 3,373,437 by Sweet et al).

Piezoelectric inkjet printers are also one form of commonly utilized inkjet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode form of operation of a piezoelectric crystal, Stemme in U.S. Pat. No. 3,747,120 (1972) which discloses a bend mode of piezoelectric operation, Howkins in U.S. Pat. No. 4,459,601 which discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclose ink jet printing techniques which rely on the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction and operation, durability and consumables.

### SUMMARY OF THE INVENTION

In accordance with a first aspect of the present invention, there is provided a nozzle arrangement for an ink jet printhead, the arrangement comprising: a nozzle chamber defined in a wafer substrate for the storage of ink to be ejected; an ink ejection port having a rim formed on one wall of the chamber; and a series of actuators attached to the wafer substrate, and forming a portion of the wall of the nozzle chamber adjacent the rim, the actuator paddles further being actuated in unison so as to eject ink from the nozzle chamber via the ink ejection nozzle.

The actuators can include a surface which bends inwards away from the centre of the nozzle chamber upon actuation. The actuators are preferably actuated by means of a thermal actuator device. The thermal actuator device may comprise a conductive resistive heating element encased within a material having a high coefficient of thermal expansion. The element can be serpentine to allow for substantially unhindered expansion of the material. The actuators are preferably arranged radially around the nozzle rim.

The actuators can form a membrane between the nozzle chamber and an external atmosphere of the arrangement and the actuators bend away from the external atmosphere to cause an increase in pressure within the nozzle chamber thereby initiating a consequential ejection of ink from the nozzle chamber. The actuators can bend away from a central axis of the nozzle chamber.

The nozzle arrangement can be formed on the wafer substrate utilizing micro-electro mechanical techniques and further can comprise an ink supply channel in communication with the nozzle chamber. The ink supply channel may be etched through the wafer. The nozzle arrangement may include a series of struts which support the nozzle rim.

The arrangement can be formed adjacent to neighbouring arrangements so as to form a pagewidth printhead.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIGS. 1-3 are schematic sectional views illustrating the operational principles of the preferred embodiment;

FIG. 4(a) and FIG. 4(b) are again schematic sections illustrating the operational principles of the thermal actuator device;

FIG. 5 is a side perspective view, partly in section, of a single nozzle arrangement constructed in accordance with the preferred embodiments;

FIGS. 6-13 are side perspective views, partly in section, illustrating the manufacturing steps of the preferred embodiments;

FIG. 14 illustrates an array of ink jet nozzles formed in accordance with the manufacturing procedures of the preferred embodiment;

FIG. 15 provides a legend of the materials indicated in FIGS. 16 to 23; and

FIG. 16 to FIG. 23 illustrate sectional views of the manufacturing steps in one form of construction of a nozzle arrangement in accordance with the invention.

### DESCRIPTION OF PREFERRED AND OTHER EMBODIMENTS

In the preferred embodiment, ink is ejected out of a nozzle chamber via an ink ejection port using a series of radially positioned thermal actuator devices that are arranged about the ink ejection port and are activated to pressurize the ink within the nozzle chamber thereby causing the ejection of ink through the ejection port.

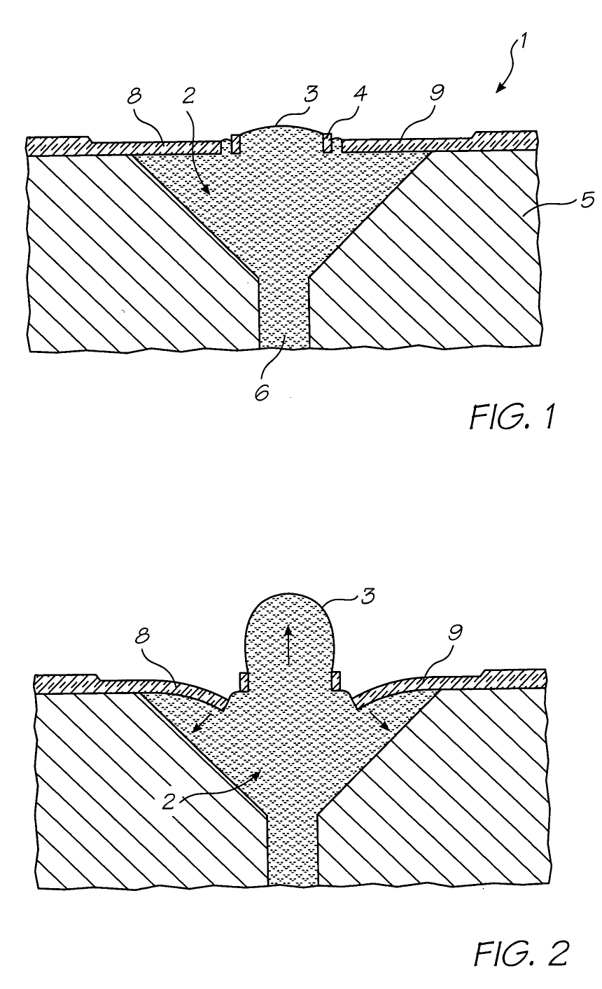

Turning now to FIGS. 1, 2 and 3, there is illustrated the basic operational principles of the preferred embodiment. FIG. 1 illustrates a single nozzle arrangement 1 in its quiescent state. The arrangement 1 includes a nozzle chamber 2 which is normally filled with ink so as to form a meniscus 3 in an ink ejection port 4. The nozzle chamber 2 is formed within a wafer 5. The nozzle chamber 2 is supplied with ink via an ink supply channel 6 which is etched through the wafer 5 with a highly isotropic plasma etching system. A suitable etcher can be the Advance Silicon Etch (ASE) system available from Surface Technology Systems of the United Kingdom.

A top of the nozzle arrangement 1 includes a series of radially positioned actuators 8, 9. These actuators comprise a polytetrafluoroethylene (PTFE) layer and an internal serpentine copper core 17. Upon heating of the copper core 17, the surrounding PTFE expands rapidly resulting in a generally downward movement of the actuators 8, 9. Hence, when it is desired to eject ink from the ink ejection port 4, a current is passed through the actuators 8, 9 which results in them bending generally downwards as illustrated in FIG. 2. The downward bending movement of the actuators 8, 9 results in a substantial increase in pressure within the nozzle chamber 2. The increase in pressure in the nozzle chamber 2 results in an expansion of the meniscus 3 as illustrated in FIG. 2.

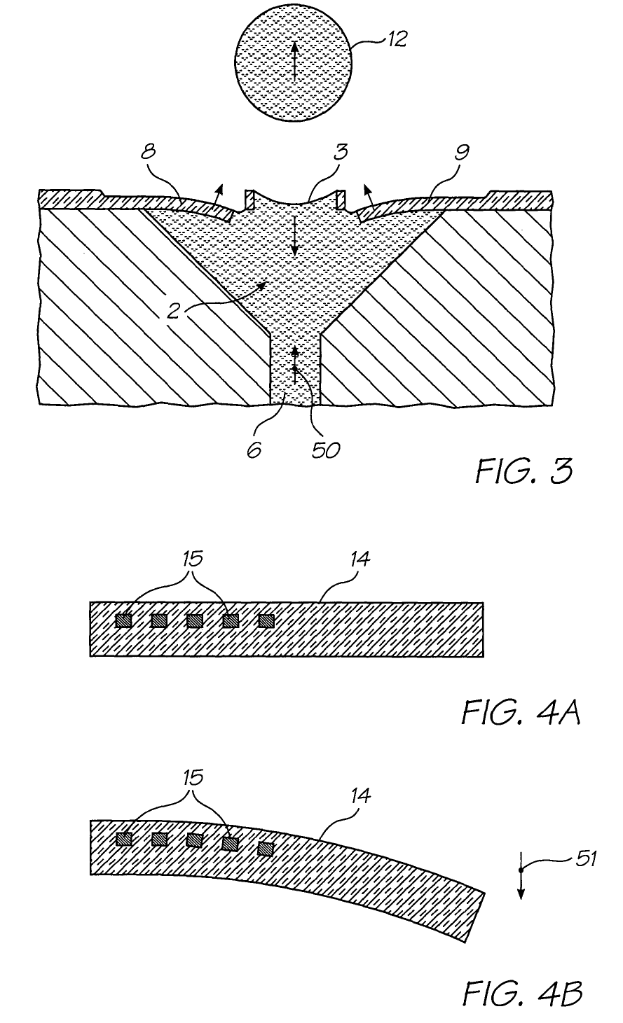

The actuators 8, 9 are activated only briefly and subsequently deactivated. Consequently, the situation is as illustrated in FIG. 3 with the actuators 8, 9 returning to their original positions. This results in a general inflow of ink back into the nozzle chamber 2 and a necking and breaking of the meniscus 3 resulting in the ejection of a drop 12. The necking and breaking of the meniscus 3 is a consequence of the forward momentum of the ink associated with drop 12 and the backward pressure experienced as a result of the return of the actuators 8, 9 to their original positions. The return of the actuators 8,9 also results in a general inflow of ink from the channel 6 as a result of surface tension effects and, eventually, the state returns to the quiescent position as illustrated in FIG. 1.

FIGS. 4(a) and 4(b) illustrate the principle of operation of the thermal actuator. The thermal actuator is preferably constructed from a material 14 having a high coefficient of thermal expansion. Embedded within the material 14 are a series of heater elements 15 which can be a series of conductive elements designed to carry a current. The conductive elements 15 are heated by passing a current through the elements 15 with the heating resulting in a general increase in temperature in the area around the heating elements 15. The position of the elements 15 is such that uneven heating of the material 14 occurs. The uneven increase in temperature causes a corresponding uneven expansion of the material 14. Hence, as illustrated in FIG. 4(b), the PTFE is bent generally in the direction shown.

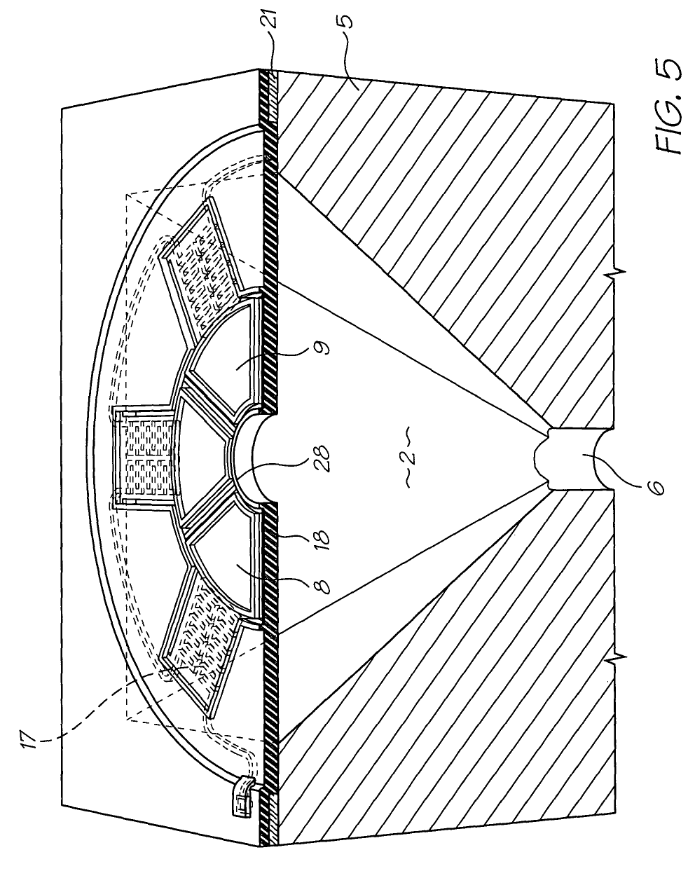

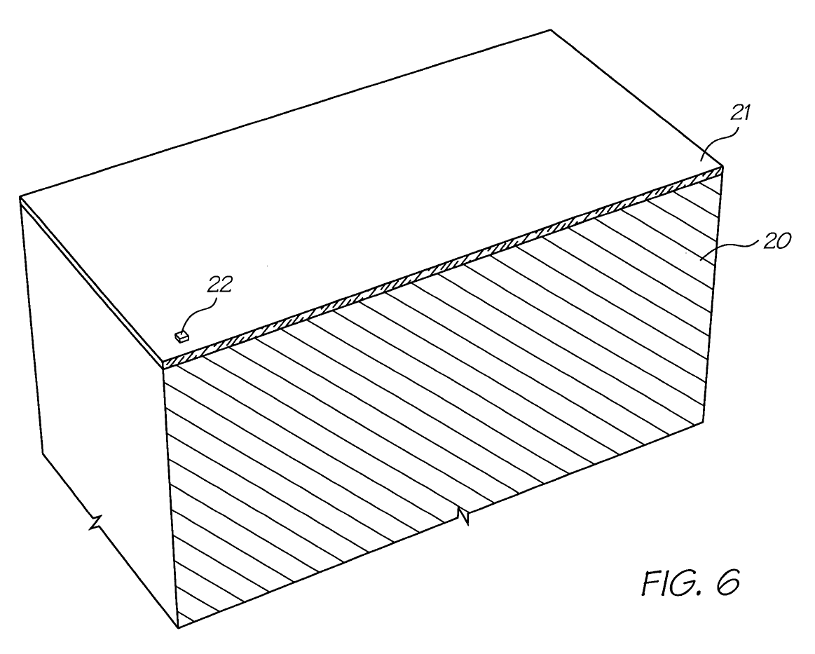

In FIG. 5, there is illustrated a side perspective view of one embodiment of a nozzle arrangement constructed in accordance with the principles previously outlined. The nozzle chamber 2 is formed with an isotropic surface etch of the wafer 5. The wafer 5 can include a CMOS layer including all the required power and drive circuits. Further, the actuators 8, 9 each have a leaf or petal formation which extends towards a nozzle rim 28 defining the ejection port 4. The normally inner end of each leaf or petal formation is displaceable with respect to the nozzle rim 28. Each activator 8, 9 has an internal copper core 17 defining the element 15. The core 17 winds in a serpentine manner to provide for substantially unhindered expansion of the actuators 8, 9. The operation of the actuators 8, 9 is as illustrated in FIG. 4(a) and FIG. 4(b) such that, upon activation, the actuators 8 bend as previously described resulting in a displacement of each petal formation away from the nozzle rim 28 and into the nozzle chamber 2. The ink supply channel 6 can be created via a deep silicon back edge of the wafer 5 utilizing a plasma etcher or the like. The copper or aluminium core 17 can provide a complete circuit. A central arm 18 which can include both metal and PTFE portions provides the main structural support for the actuators 8, 9.

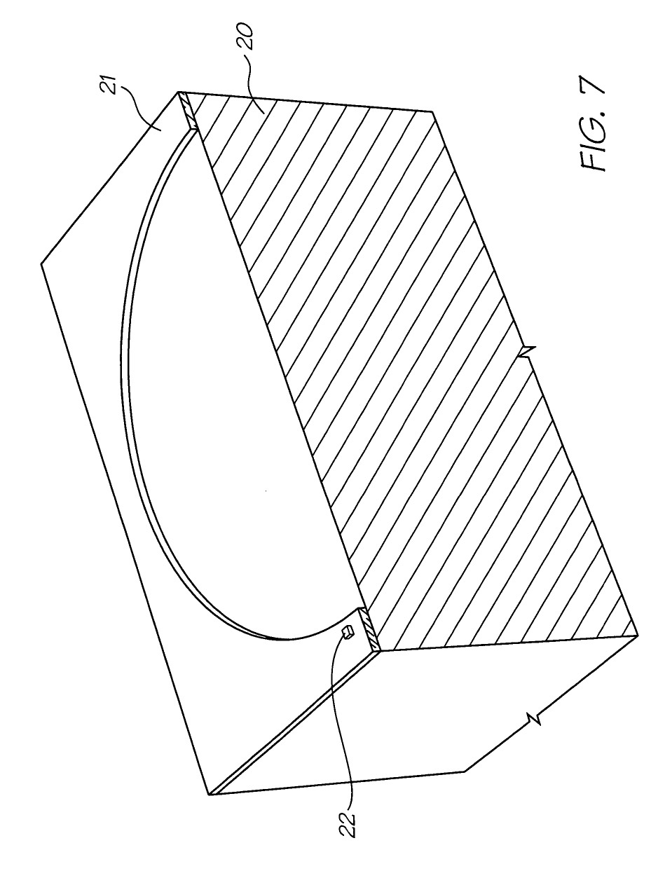

Turning now to FIG. 6 to FIG. 13, one form of manufacture of the nozzle arrangement 1 in accordance with the principles of the preferred embodiment is shown. The nozzle arrangement 1 is preferably manufactured using microelectromechanical (MEMS) techniques and can include the following construction techniques:

As shown initially in FIG. 6, the initial processing starting material is a standard semi-conductor wafer 20 having a complete CMOS level 21 to a first level of metal. The first level of metal includes portions 22 which are utilized for providing power to the thermal actuators 8, 9.

The first step, as illustrated in FIG. 7, is to etch a nozzle region down to the silicon wafer 20 utilizing an appropriate mask.

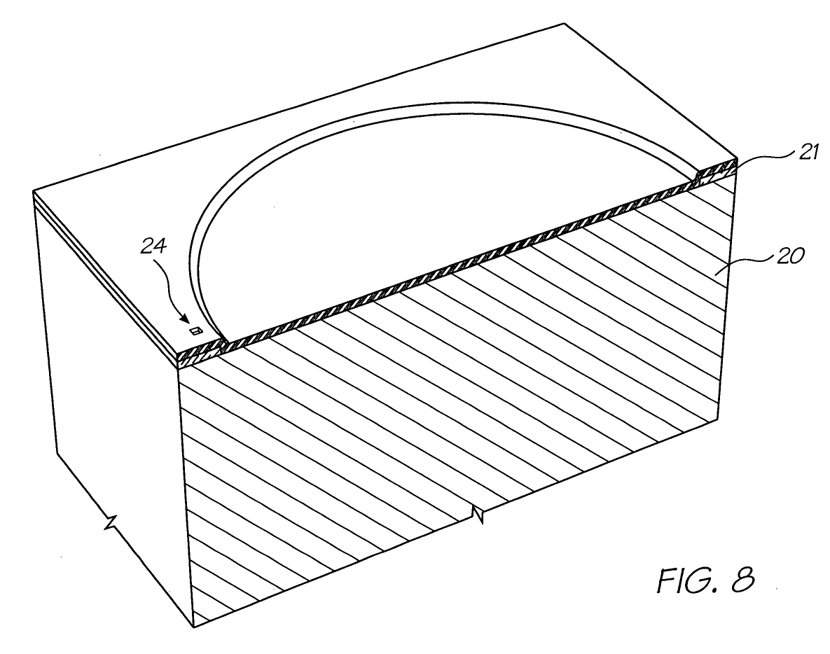

Next, as illustrated in FIG. 8, a 2 μm layer of polytetrafluoroethylene (PTFE) is deposited and etched so as to define vias 24 for interconnecting multiple levels.

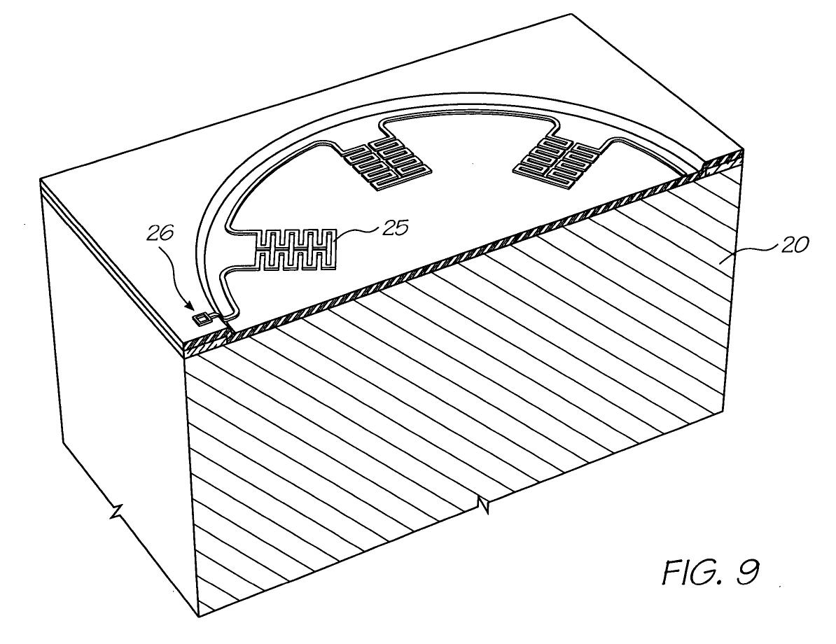

Next, as illustrated in FIG. 9, the second level metal layer is deposited, masked and etched to define a heater structure 25. The heater structure 25 includes via 26 interconnected with a lower aluminium layer.

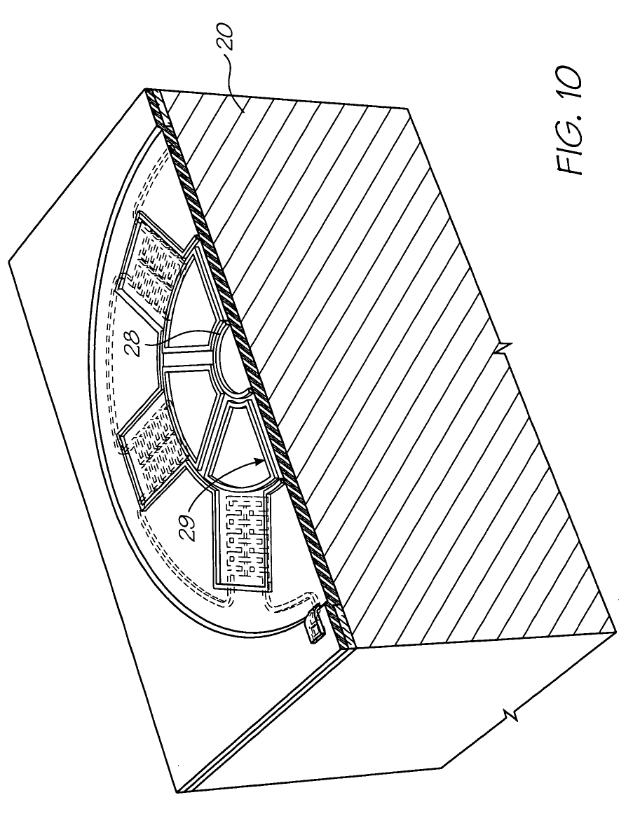

Next, as illustrated in FIG. 10, a further 2 μm layer of PTFE is deposited and etched to the depth of 1 μm utilizing a nozzle rim mask to define the nozzle rim 28 in addition to ink flow guide rails 29 which generally restrain any wicking along the surface of the PTFE layer. The guide rails 29 surround small thin slots and, as such, surface tension effects are a lot higher around these slots which in turn results in minimal outflow of ink during operation.

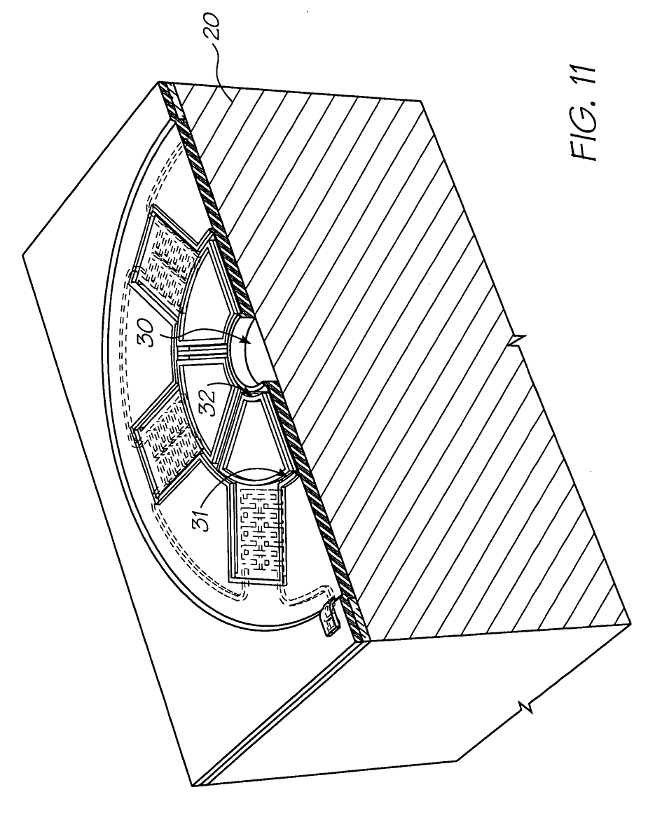

Next, as illustrated in FIG. 11, the PTFE is etched utilizing a nozzle and actuator mask to define a port portion 30 and slots 31 and 32.

Next, as illustrated in FIG. 12, the wafer is crystallographically etched on a <111> plane utilizing a standard crystallographic etchant such as KOH. The etching forms a chamber 33, directly below the port portion 30.

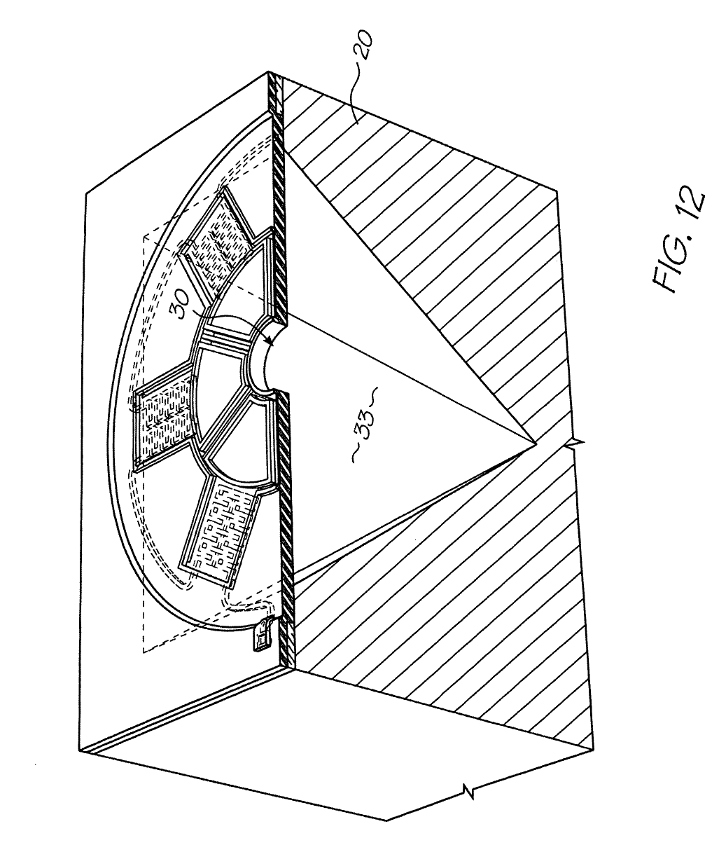

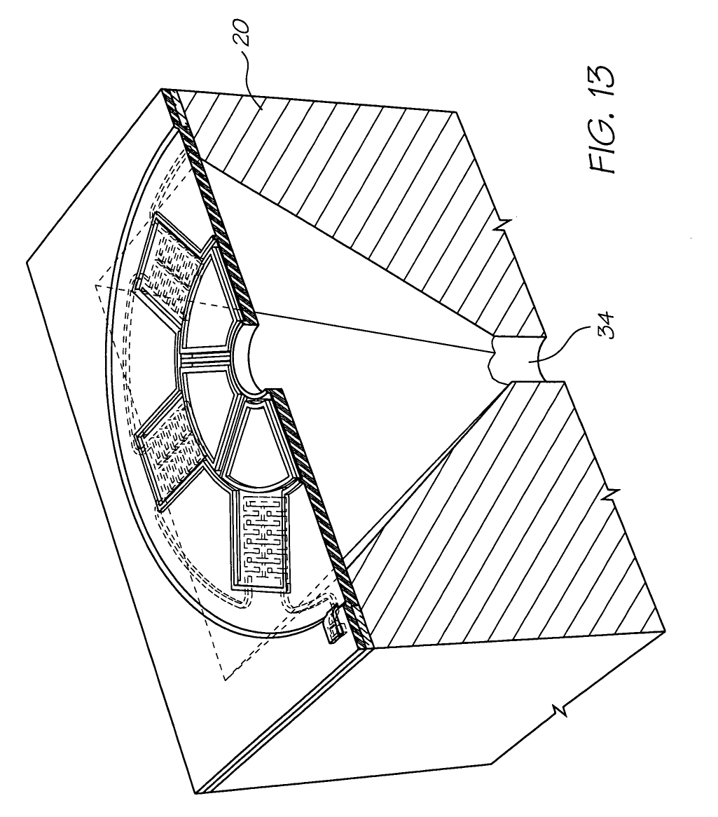

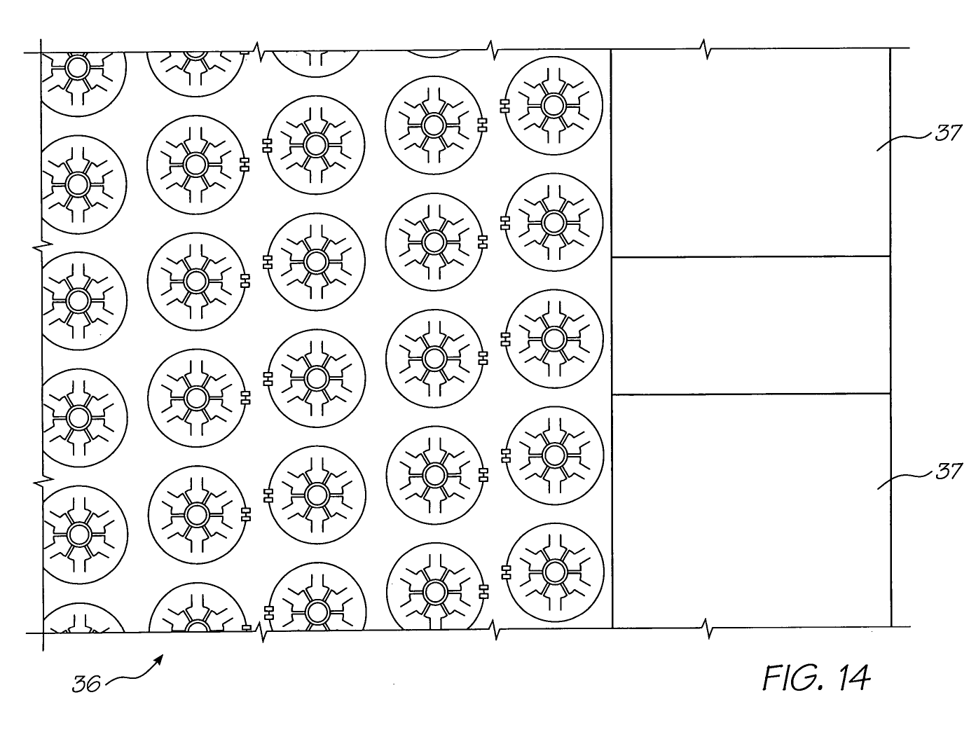

In FIG. 13, the ink supply channel 34 can be etched from the back of the wafer utilizing a highly anisotropic etcher such as the STS etcher from Silicon Technology Systems of United Kingdom. An array of ink jet nozzles can be formed simultaneously with a portion of an array 36 being illustrated in FIG. 14. A portion of the printhead is formed simultaneously and diced by the STS etching process. The array 36 shown provides for four column printing with each separate column attached to a different colour ink supply channel being supplied from the back of the wafer. Bond pads 37 provide for electrical control of the ejection mechanism.

In this manner, large pagewidth printheads can be fabricated so as to provide for a drop-on-demand ink ejection mechanism.

One form of detailed manufacturing process which can be used to fabricate monolithic inkjet printheads operating in accordance with the principles taught by the present embodiment can proceed utilizing the following steps:

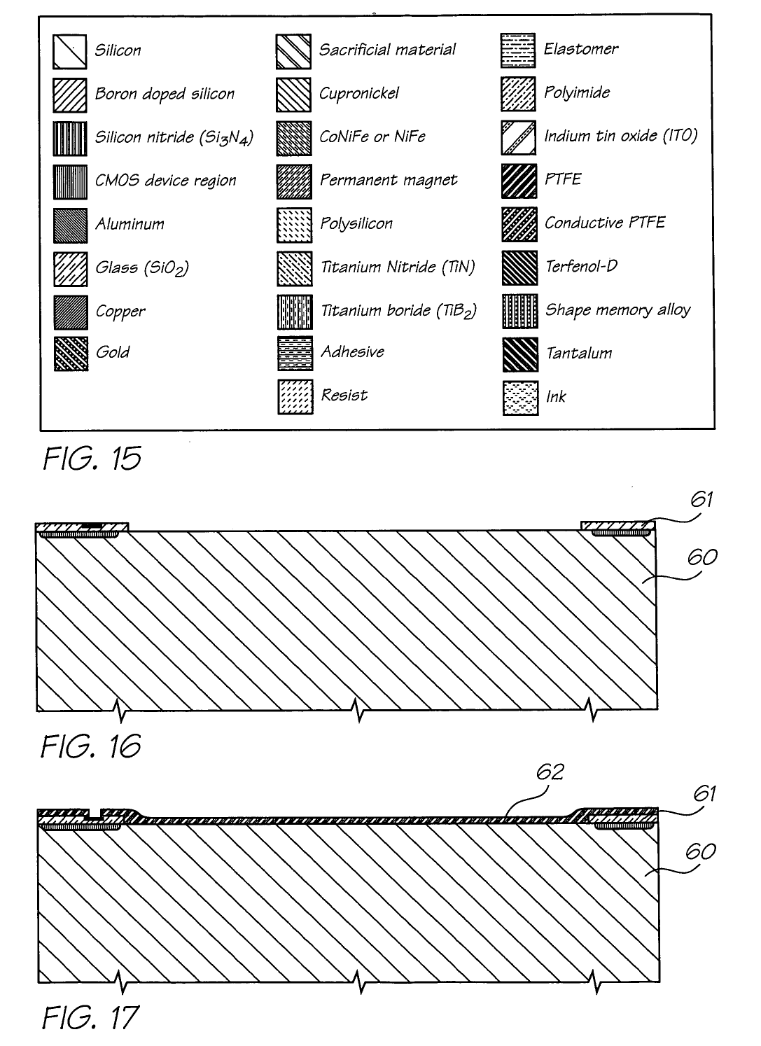

1. Using a double-sided polished wafer 60, complete a 0.5 micron, one poly, 2 metal CMOS process 61. This step shown in FIG. 16. For clarity, these diagrams may not be to scale, and may not represent a cross section though any single plane of the nozzle. FIG. 15 is a key to representations of various materials in these manufacturing diagrams, and those of other cross referenced ink jet configurations.

2. Etch the CMOS oxide layers down to silicon or second level metal using Mask 1. This mask defines the nozzle cavity and the edge of the chips. This step is shown in FIG. 16.

3. Deposit a thin layer (not shown) of a hydrophilic polymer, and treat the surface of this polymer for PTFE adherence.

4. Deposit 1.5 microns of polytetrafluoroethylene (PTFE) 62.

5. Etch the PTFE and CMOS oxide layers to second level metal using Mask 2. This mask defines the contact vias for the heater electrodes. This step is shown in FIG. 17.

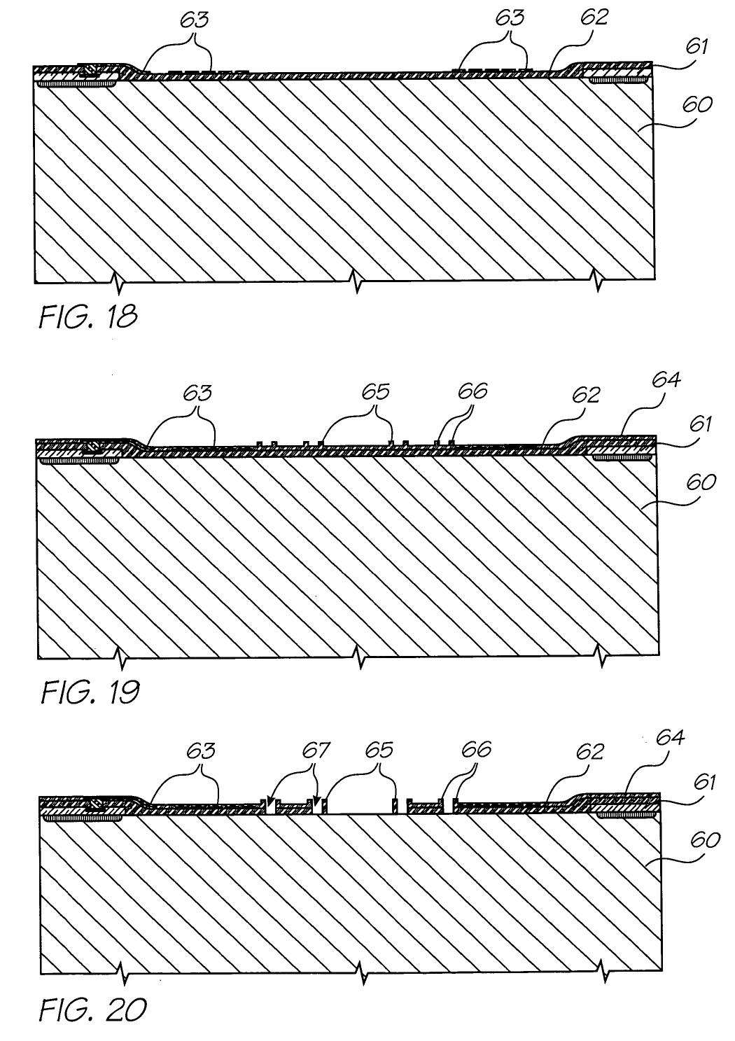

6. Deposit and pattern 0.5 microns of gold 63 using a lift-off process using Mask 3. This mask defines the heater pattern. This step is shown in FIG. 18.

7. Deposit 1.5 microns of PTFE 64.

8. Etch 1 micron of PTFE using Mask 4. This mask defines the nozzle rim 65 and the rim at the edge 66 of the nozzle chamber. This step is shown in FIG. 19.

9. Etch both layers of PTFE and the thin hydrophilic layer down to silicon using Mask 5. This mask defines a gap 67 at inner edges of the actuators, and the edge of the chips. It also forms the mask for a subsequent crystallographic etch. This step is shown in FIG. 20.

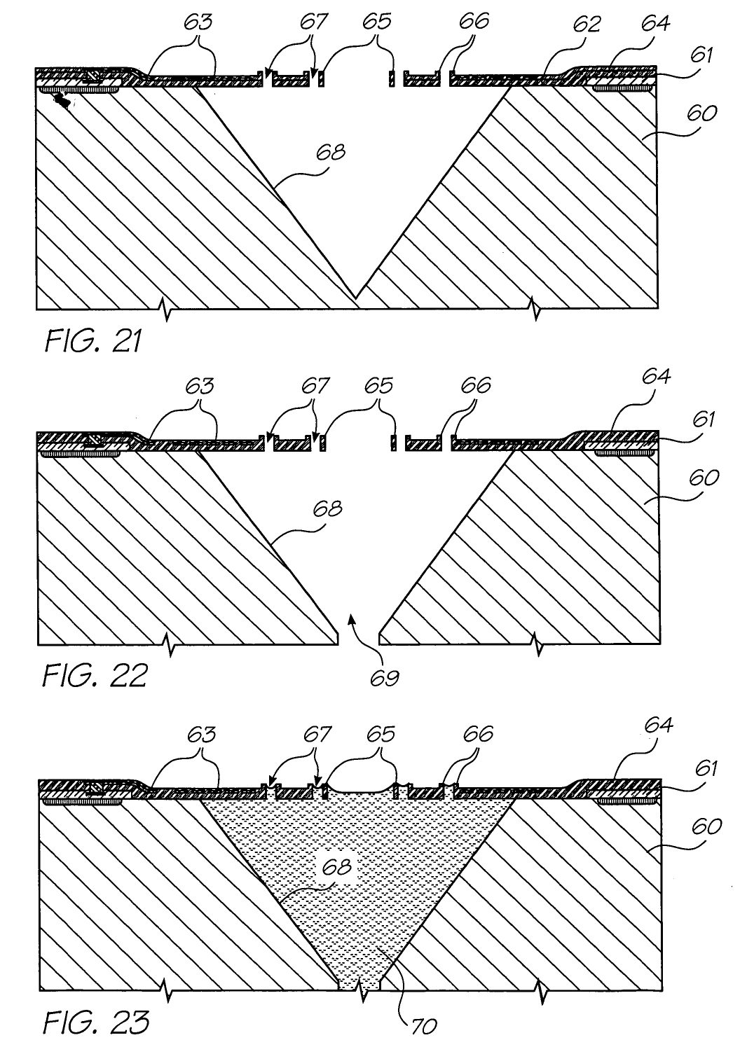

10. Crystallographically etch the exposed silicon using KOH. This etch stops on <111> crystallographic planes 68, forming an inverted square pyramid with sidewall angles of 54.74 degrees. This step is shown in FIG. 21.

11. Back-etch through the silicon wafer (with, for example, an ASE Advanced Silicon Etcher from Surface Technology Systems) using Mask 6. This mask defines the ink inlets 69 which are etched through the wafer. The wafer is also diced by this etch. This step is shown in FIG. 22.

12. Mount the printheads in their packaging, which may be a molded plastic former incorporating ink channels which supply the appropriate color ink to the ink inlets 69 at the back of the wafer.

13. Connect the printheads to their interconnect systems. For a low profile connection with minimum disruption of airflow, TAB may be used. Wire bonding may also be used if the printer is to be operated with sufficient clearance to the paper.

14. Fill the completed print heads with ink 70 and test them. A filled nozzle is shown in FIG. 23.

The presently disclosed ink jet printing technology is potentially suited to a wide range of printing systems including: color and monochrome office printers, short run digital printers, high speed digital printers, offset press supplemental printers, low cost scanning printers high speed pagewidth printers, notebook computers with inbuilt pagewidth printers, portable color and monochrome printers, color and monochrome copiers, color and monochrome facsimile machines, combined printer, facsimile and copying machines, label printers, large format plotters, photograph copiers, printers for digital photographic “minilabs”, video printers, PHOTO CD (PHOTO CD is a registered trade mark of the Eastman Kodak Company) printers, portable printers for PDAs, wallpaper printers, indoor sign printers, billboard printers, fabric printers, camera printers and fault tolerant commercial printer arrays.

It would be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

Ink Jet Technologies

The embodiments of the invention use an ink jet printer type device. Of course many different devices could be used. However presently popular ink jet printing technologies are unlikely to be suitable.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. This leads to an efficiency of around 0.02%, from electricity input to drop momentum (and increased surface area) out.

The most significant problem with piezoelectric inkjet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty-five different ink jet technologies have been developed by the Assignee to give a wide range of choices for high volume manufacture. These technologies form part of separate applications assigned to the present Assignee as set out in the table below under the heading Cross References to Related Applications.

The ink jet designs shown here are suitable for a wide range of digital printing systems, from battery powered one-time use digital cameras, through to desktop and network printers, and through to commercial printing systems.

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest printhead designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The printhead is connected to the camera circuitry by tape automated bonding.

Tables of Drop-on-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of ink jet nozzle. While not all of the possible combinations result in a viable ink jet technology, many million configurations are viable. It is clearly impractical to elucidate all of the possible configurations. Instead, certain inkjet types have been investigated in detail. These are designated IJ01 to IJ45 above which matches the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet printheads with characteristics superior to any currently available ink jet technology.

Where there are prior art examples known to the inventor, one or more of these examples are listed in the examples column of the tables below. The IJ01 to IJ45 series are also listed in the examples column. In some cases, print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

| | | | |
|---|---|---|---|
| Description | Advantages | Disadvantages | Examples |

ACTUATOR MECHANISM (APPLIED ONLY TO SELECTED INK DROPS)

| | | | | |
|---|---|---|---|---|
| Thermal | An electrothermal | Large force | High power | Canon Bubblejet |
| bubble | heater heats the ink to | generated | Ink carrier limited to | 1979 Endo et al GB |
| | above boiling point, | Simple construction | water | patent 2,007,162 |
| | transferring significant | No moving parts | Low efficiency | Xerox heater-in-pit |
| | heat to the aqueous | Fast operation | High temperatures | 1990 Hawkins et al |
| | ink. A bubble | Small chip area | required | USP 4,899,181 |
| | nucleates and quickly | required for actuator | High mechanical | Hewlett-Packard TIJ |
| | forms, expelling the | | stress | 1982 Vaught et al |
| | ink. | | Unusual materials | USP 4,490,728 |
| | The efficiency of the | | required | |
| | process is low, with | | Large drive | |
| | typically less than | | transistors | |
| | 0.05% of the electrical | | Cavitation causes | |
| | energy being | | actuator failure | |
| | transformed into | | Kogation reduces | |
| | kinetic energy of the | | bubble formation | |
| | drop. | | Large print heads | |
| | | | are difficult to | |
| | | | fabricate | |
| Piezoelectric | A piezoelectric crystal | Low power | Very large area | Kyser et al USP |
| | such as lead | consumption | required for actuator | 3,946,398 |
| | lanthanum zirconate | Many ink types can | Difficult to integrate | Zoltan USP |
| | (PZT) is electrically | be used | with electronics | 3,683,212 |
| | activated, and either | Fast operation | High voltage drive | 1973 Stemme USP |
| | expands, shears, or | High efficiency | transistors required | 3,747,120 |
| | bends to apply | | Full pagewidth print | Epson Stylus |
| | pressure to the ink, | | heads impractical | Tektronix |
| | ejecting drops. | | due to actuator size | IJ04 |
| | | | Requires electrical | |
| | | | poling in high field | |
| | | | strengths during | |
| | | | manufacture | |
| Electrostrictive | An electric field is | Low power | Low maximum | Seiko Epson, Usui |
| | used to activate | consumption | strain (approx. | et all JP 253401/96 |
| | electrostriction in | Many ink types can | 0.01%) | IJ04 |
| | relaxor materials such | be used | Large area required | |
| | as lead lanthanum | Low thermal | for actuator due to | |
| | zirconate titanate | expansion | low strain | |
| | (PLZT) or lead | Electric field | Response speed is | |
| | magnesium niobate | strength required | marginal (˜10 | |
| | (PMN). | (approx. 3.5 V/μm) | μs) | |
| | | can | High voltage drive | |
| | | be generated | transistors required | |
| | | without difficulty | Full pagewidth print | |
| | | Does not require | heads impractical | |
| | | electrical poling | due to actuator size | |
| Ferroelectric | An electric field is | Low power | Difficult to integrate | IJ04 |
| | used to induce a phase | consumption | with electronics | |
| | transition between the | Many ink types can | Unusual materials | |
| | antiferroelectric (AFE) | be used | such as PLZSnT are | |
| | and ferroelectric (FE) | Fast operation (<1 | required | |
| | phase. Perovskite | μs) | Actuators require a | |
| | materials such as tin | Relatively high | large area | |
| | modified lead | longitudinal strain | | |
| | lanthanum zirconate | High efficiency | | |
| | titanate (PLZSnT) | Electric field | | |
| | exhibit large strains of | strength of around 3 V/μm | | |
| | up to 1% associated | can be | | |
| | with the AFE to FE | readily provided | | |
| | phase transition. | | | |
| Electrostatic | Conductive plates are | Low power | Difficult to operate | IJ02, IJ04 |
| plates | separated by a | consumption | electrostatic devices | |
| | compressible or fluid | Many ink types can | in an aqueous | |
| | dielectric (usually air). | be used | environment | |
| | Upon application of a | Fast operation | The electrostatic | |
| | voltage, the plates | | actuator will | |
| | attract each other and | | normally need to be | |
| | displace ink, causing | | separated from the | |
| | drop ejection. The | | ink | |
| | conductive plates may | | Very large area | |
| | be in a comb or | | required to achieve | |
| | honeycomb structure, | | high forces | |
| | or stacked to increase | | High voltage drive | |
| | the surface area and | | transistors may be | |
| | therefore the force. | | required | |
| | | | Full pagewidth print | |
| | | | heads are not | |
| | | | competitive due to | |
| | | | actuator size | |
| Electrostatic | A strong electric field | Low current | High voltage | 1989 Saito et al, |
| pull | is applied to the ink, | consumption | required | USP 4,799,068 |
| on ink | whereupon | Low temperature | May be damaged by | 1989 Miura et al, |
| | electrostatic attraction | | sparks due to air | USP 4,810,954 |
| | accelerates the ink | | breakdown | Tone-jet |
| | towards the print | | Required field | |
| | medium. | | strength increases as | |
| | | | the drop size | |
| | | | decreases | |
| | | | High voltage drive | |
| | | | transistors required | |
| | | | Electrostatic field | |
| | | | attracts dust | |
| Permanent | An electromagnet | Low power | Complex fabrication | IJ07, IJ10 |
| magnet | directly attracts a | consumption | Permanent magnetic | |
| electromagnetic | permanent magnet, | Many ink types can | material such as | |
| | displacing ink and | be used | Neodymium Iron | |
| | causing drop ejection. | Fast operation | Boron (NdFeB) | |
| | Rare earth magnets | High efficiency | required. | |
| | with a field strength | Easy extension from | High local currents | |
| | around 1 Tesla can be | single nozzles to | required | |
| | used. Examples are: | pagewidth print | Copper metalization | |
| | Samarium Cobalt | heads | should be used for | |
| | (SaCo) and magnetic | | long | |
| | materials in the | | electromigration | |
| | neodymium iron boron | | lifetime and low | |
| | family (NdFeB, | | resistivity | |
| | NdDyFeBNb, | | Pigmented inks are | |
| | NdDyFeB, etc) | | usually infeasible | |
| | | | Operating | |
| | | | temperature limited | |
| | | | to the Curie | |
| | | | temperature (around | |
| | | | 540K) | |
| Soft | A solenoid induced a | Low power | Complex fabrication | IJ01, IJ05, IJ08, |
| magnetic | magnetic field in a soft | consumption | Materials not | IJ10, IJ12, IJ14, |
| core electromagnetic | magnetic core or yoke | Many ink types can | usually present in a | IJ15, IJ17 |
| | fabricated from a | be used | CMOS fab such as | |
| | ferrous material such | Fast operation | NiFe, CoNiFe, or | |
| | as electroplated iron | High efficiency | CoFe are required | |
| | alloys such as CoNiFe | Easy extension from | High local currents | |
| | [1], CoFe, or NiFe | single nozzles to | required | |
| | alloys. Typically, the | pagewidth print | Copper metalization | |
| | soft magnetic material | heads | should be used for | |
| | is in two parts, which | | long | |
| | are normally held | | electromigration | |
| | apart by a spring. | | lifetime and low | |
| | When the solenoid is | | resistivity | |
| | actuated, the two parts | | Electroplating is | |
| | attract, displacing the | | required | |
| | ink. | | High saturation flux | |
| | | | density is required | |
| | | | (2.0-2.1 T is | |
| | | | achievable with | |
| | | | CoNiFe [1]) | |
| Lorenz | The Lorenz force | Low power | Force acts as a | IJ06, IJ11, IJ13, |
| force | acting on a current | consumption | twisting motion | IJ16 |
| | carrying wire in a | Many ink types can | Typically, only a | |
| | magnetic field is | be used | quarter of the | |
| | utilized. | Fast operation | solenoid length | |
| | This allows the | High efficiency | provides force in a | |
| | magnetic field to be | Easy extension from | useful direction | |
| | supplied externally to | single nozzles to | High local currents | |
| | the print head, for | pagewidth print | required | |
| | example with rare | heads | Copper metalization | |
| | earth permanent | | should be used for | |
| | magnets. | | long | |
| | Only the current | | electromigration | |
| | carrying wire need be | | lifetime and low | |
| | fabricated on the print- | | resistivity | |
| | head, simplifying | | Pigmented inks are | |
| | materials | | usually infeasible | |
| | requirements. | | | |
| Magnetostriction | The actuator uses the | Many ink types can | Force acts as a | Fischenbeck, USP |
| | giant magnetostrictive | be used | twisting motion | 4,032,929 |
| | effect of materials | Fast operation | Unusual materials | IJ25 |
| | such as Terfenol-D (an | Easy extension from | such as Terfenol-D | |
| | alloy of terbium, | single nozzles to | are required | |
| | dysprosium and iron | pagewidth print | High local currents | |
| | developed at the Naval | heads | required | |
| | Ordnance Laboratory, | High force is | Copper metalization | |
| | hence Ter-Fe-NOL). | available | should be used for | |
| | For best efficiency, the | | long | |
| | actuator should be pre- | | electromigration | |
| | stressed to approx. 8 MPa. | | lifetime and low | |
| | | | resistivity | |
| | | | Pre-stressing may | |
| | | | be required | |
| Surface | Ink under positive | Low power | Requires | Silverbrook, EP |
| tension | pressure is held in a | consumption | supplementary force | 0771 658 A2 and |
| reduction | nozzle by surface | Simple construction | to effect drop | related patent |
| | tension. The surface | No unusual | separation | applications |
| | tension of the ink is | materials required in | Requires special ink | |
| | reduced below the | fabrication | surfactants | |
| | bubble threshold, | High efficiency | Speed may be | |
| | causing the ink to | Easy extension from | limited by surfactant | |
| | egress from the | single nozzles to | properties | |
| | nozzle. | pagewidth print | | |
| | | heads | | |
| Viscosity | The ink viscosity is | Simple construction | Requires | Silverbrook, EP |
| reduction | locally reduced to | No unusual | supplementary force | 0771 658 A2 and |
| | select which drops are | materials required in | to effect drop | related patent |
| | to be ejected. A | fabrication | separation | applications |
| | viscosity reduction can | Easy extension from | Requires special ink | |
| | be achieved | single nozzles to | viscosity properties | |
| | electrothermally with | pagewidth print | High speed is | |
| | most inks, but special | heads | difficult to achieve | |
| | inks can be engineered | | Requires oscillating | |
| | for a 100:1 viscosity | | ink pressure | |
| | reduction. | | A high temperature | |
| | | | difference (typically | |
| | | | 80 degrees) is | |
| | | | required | |
| Acoustic | An acoustic wave is | Can operate without | Complex drive | 1993 Hadimioglu et |
| | generated and | a nozzle plate | circuitry | al, EUP 550,192 |
| | focussed upon the | | Complex fabrication | 1993 Elrod et al, |
| | drop ejection region. | | Low efficiency | EUP 572,220 |
| | | | Poor control of drop | |
| | | | position | |
| | | | Poor control of drop | |
| | | | volume | |
| Thermoelastic | An actuator which | Low power | Efficient aqueous | IJ03, IJ09, IJ17, |
| bend | relies upon differential | consumption | operation requires a | IJ18, IJ19, IJ20, |
| actuator | thermal expansion | Many ink types can | thermal insulator on | IJ21, IJ22, IJ23, |
| | upon Joule heating is | be used | the hot side | IJ24, IJ27, IJ28, |
| | used. | Simple planar | Corrosion | IJ29, IJ30, IJ31, |
| | | fabrication | prevention can be | IJ32, IJ33, IJ34, |
| | | Small chip area | difficult | IJ35, IJ36, IJ37, |
| | | required for each | Pigmented inks may | IJ38, IJ39, IJ40, |
| | | actuator | be infeasible, as | IJ41 |
| | | Fast operation | pigment particles | |
| | | High efficiency | may jam the bend | |
| | | CMOS compatible | actuator | |
| | | voltages and | | |
| | | currents | | |
| | | Standard MEMS | | |
| | | processes can be | | |
| | | used | | |
| | | Easy extension from | | |
| | | single nozzles to | | |
| | | pagewidth print | | |
| | | heads | | |
| High CTE | A material with a very | High force can be | Requires special | IJ09, IJ17, IJ18, |
| thermoelastic | high coefficient of | generated | material (e.g. PTFE) | IJ20, IJ21, IJ22, |
| actuator | thermal expansion | Three methods of | Requires a PTFE | IJ23, IJ24, IJ27, |
| | (CTE) such as | PTFE deposition are | deposition process, | IJ28, IJ29, IJ30, |
| | polytetrafluoroethylene | under development: | which is not yet | IJ31, IJ42, IJ43, |
| | (PTFE) is used. As | chemical vapor | standard in ULSI | IJ44 |
| | high CTE materials | deposition (CVD), | fabs | |
| | are usually non- | spin coating, and | PTFE deposition | |
| | conductive, a heater | evaporation | cannot be followed | |
| | fabricated from a | PTFE is a candidate | with high | |
| | conductive material is | for low dielectric | temperature (above | |
| | incorporated. A 50 | constant insulation | 350° C.) processing | |
| | μm long PTFE | in ULSI | Pigmented inks may | |
| | bend actuator with | Very low power | be infeasible, as | |
| | polysilicon heater and | consumption | pigment particles | |
| | 15 mW power input | Many ink types can | may jam the bend | |
| | can provide 180 | be used | actuator | |
| | μN force | Simple planar | | |
| | and 10 μm | fabrication | | |
| | deflection. Actuator | Small chip area | | |
| | motions include: | required for each | | |
| | Bend | actuator | | |
| | Push | Fast operation | | |
| | Buckle | High efficiency | | |
| | Rotate | CMOS compatible | | |
| | | voltages and | | |
| | | currents | | |
| | | Easy extension from | | |
| | | single nozzles to | | |
| | | pagewidth print | | |
| | | heads | | |
| Conductive | A polymer with a high | High force can be | Requires special | IJ24 |
| polymer | coefficient of thermal | generated | materials | |
| thermoelastic | expansion (such as | Very low power | development (High | |
| actuator | PTFE) is doped with | consumption | CTE conductive | |
| | conducting substances | Many ink types can | polymer) | |
| | to increase its | be used | Requires a PTFE | |
| | conductivity to about 3 | Simple planar | deposition process, | |
| | orders of magnitude | fabrication | which is not yet | |
| | below that of copper. | Small chip area | standard in ULSI | |
| | The conducting | required for each | fabs | |
| | polymer expands | actuator | PTFE deposition | |
| | when resistively | Fast operation | cannot be followed | |
| | heated. | High efficiency | with high | |
| | Examples of | CMOS compatible | temperature (above | |
| | conducting dopants | voltages and | 350° C.) processing | |
| | include: | currents | Evaporation and | |
| | Carbon nanotubes | Easy extension from | CVD deposition | |
| | Metal fibers | single nozzles to | techniques cannot | |
| | Conductive polymers | pagewidth print | be used | |
| | such as doped | heads | Pigmented inks may | |
| | polythiophene | | be infeasible, as | |
| | Carbon granules | | pigment particles | |
| | | | may jam the bend | |
| | | | actuator | |
| Shape | A shape memory alloy | High force is | Fatigue limits | IJ26 |
| memory | such as TiNi (also | available (stresses | maximum number | |
| alloy | known as Nitinol - | of hundreds of MPa) | of cycles | |
| | Nickel Titanium alloy | Large strain is | Low strain (1%) is | |
| | developed at the Naval | available (more than | required to extend | |
| | Ordnance Laboratory) | 3%) | fatigue resistance | |
| | is thermally switched | High corrosion | Cycle rate limited | |
| | between its weak | resistance | by heat removal | |
| | martensitic state and | Simple construction | Requires unusual | |
| | its high stiffness | Easy extension from | materials (TiNi) | |
| | austenic state. The | single nozzles to | The latent heat of | |
| | shape of the actuator | pagewidth print | transformation must | |
| | in its martensitic state | heads | be provided | |
| | is deformed relative to | Low voltage | High current | |
| | the austenic shape. | operation | operation | |
| | The shape change | | Requires pre- | |
| | causes ejection of a | | stressing to distort | |
| | drop. | | the martensitic state | |
| Linear | Linear magnetic | Linear Magnetic | Requires unusual | IJ12 |
| Magnetic | actuators include the | actuators can be | semiconductor | |
| Actuator | Linear Induction | constructed with | materials such as | |
| | Actuator (LIA), Linear | high thrust, long | soft magnetic alloys | |
| | Permanent Magnet | travel, and high | (e.g. CoNiFe) | |
| | Synchronous Actuator | efficiency using | Some varieties also | |
| | (LPMSA), Linear | planar | require permanent | |
| | Reluctance | semiconductor | magnetic materials | |
| | Synchronous Actuator | fabrication | such as Neodymium | |
| | (LRSA), Linear | techniques | iron boron (NdFeB) | |
| | Switched Reluctance | Long actuator travel | Requires complex | |
| | Actuator (LSRA), and | is available | multi-phase drive | |
| | the Linear Stepper | Medium force is | circuitry | |
| | Actuator (LSA). | available | High current | |
| | | Low voltage | operation | |
| | | operation | | |

BASIC OPERATION MODE

| | | | | |
|---|---|---|---|---|
| Actuator | This is the simplest | Simple operation | Drop repetition rate | Thermal ink jet |
| directly | mode of operation: the | No external fields | is usually limited to | Piezoelectric ink jet |
| pushes ink | actuator directly | required | around 10 kHz. | IJ01, IJ02, IJ03, |
| | supplies sufficient | Satellite drops can | However, this is not | IJ04, IJ05, IJ06, |
| | kinetic energy to expel | be avoided if drop | fundamental to the | IJ07, IJ09, IJ11, |
| | the drop. The drop | velocity is less than | method, but is | IJ12, IJ14, IJ16, |
| | must have a sufficient | 4 m/s | related to the refill | IJ20, IJ22, IJ23, |
| | velocity to overcome | Can be efficient, | method normally | IJ24, IJ25, IJ26, |
| | the surface tension. | depending upon the | used | IJ27, IJ28, IJ29, |
| | | actuator used | All of the drop | IJ30, IJ31, IJ32, |
| | | | kinetic energy must | IJ33, IJ34, IJ35, |
| | | | be provided by the | IJ36, IJ37, IJ38, |
| | | | actuator | IJ39, IJ40, IJ41, |
| | | | Satellite drops | IJ42, IJ43, IJ44 |
| | | | usually form if drop | |
| | | | velocity is greater | |
| | | | than 4.5 m/s | |
| Proximity | The drops to be | Very simple print | Requires close | Silverbrook, EP |
| | printed are selected by | head fabrication can | proximity between | 0771 658 A2 and |
| | some manner (e.g. | be used | the print head and | related patent |
| | thermally induced | The drop selection | the print media or | applications |
| | surface tension | means does not need | transfer roller | |
| | reduction of | to provide the | May require two | |
| | pressurized ink). | energy required to | print heads printing | |
| | Selected drops are | separate the drop | alternate rows of the | |
| | separated from the ink | from the nozzle | image | |
| | in the nozzle by | | Monolithic color | |
| | contact with the print | | print heads are | |
| | medium or a transfer | | difficult | |
| | roller. | | | |
| Electrostatic | The drops to be | Very simple print | Requires very high | Silverbrook, EP |
| pull | printed are selected by | head fabrication can | electrostatic field | 0771 658 A2 and |
| on ink | some manner (e.g. | be used | Electrostatic field | related patent |
| | thermally induced | The drop selection | for small nozzle | applications |
| | surface tension | means does not need | sizes is above air | Tone-Jet |
| | reduction of | to provide the | breakdown | |
| | pressurized ink). | energy required to | Electrostatic field | |
| | Selected drops are | separate the drop | may attract dust | |
| | separated from the ink | from the nozzle | | |
| | in the nozzle by a | | | |
| | strong electric field. | | | |
| Magnetic | The drops to be | Very simple print | Requires magnetic | Silverbrook, EP |
| pull on ink | printed are selected by | head fabrication can | ink | 0771 658 A2 and |
| | some manner (e.g. | be used | Ink colors other than | related patent |
| | thermally induced | The drop selection | black are difficult | applications |
| | surface tension | means does not need | Requires very high | |
| | reduction of | to provide the | magnetic fields | |
| | pressurized ink). | energy required to | | |
| | Selected drops are | separate the drop | | |
| | separated from the ink | from the nozzle | | |
| | in the nozzle by a | | | |
| | strong magnetic field | | | |
| | acting on the magnetic | | | |
| | ink. | | | |
| Shutter | The actuator moves a | High speed (>50 kHz) | Moving parts are | IJ13, IJ17, IJ21 |
| | shutter to block ink | operation can | required | |
| | flow to the nozzle. The | be achieved due to | Requires ink | |
| | ink pressure is pulsed | reduced refill time | pressure modulator | |
| | at a multiple of the | Drop timing can be | Friction and wear | |
| | drop ejection | very accurate | must be considered | |
| | frequency. | The actuator energy | Stiction is possible | |
| | | can be very low | | |
| Shuttered | The actuator moves a | Actuators with | Moving parts are | IJ08, IJ15, IJ18, |
| grill | shutter to block ink | small travel can be | required | IJ19 |
| | flow through a grill to | used | Requires ink | |
| | the nozzle. The shutter | Actuators with | pressure modulator | |
| | movement need only | small force can be | Friction and wear | |
| | be equal to the width | used | must be considered | |
| | of the grill holes. | High speed (>50 kHz) | Stiction is possible | |
| | | operation can | | |
| | | be achieved | | |
| Pulsed | A pulsed magnetic | Extremely low | Requires an external | IJ10 |
| magnetic | field attracts an ‘ink | energy operation is | pulsed magnetic | |
| pull on ink | pusher’ at the drop | possible | field | |
| pusher | ejection frequency. An | No heat dissipation | Requires special | |
| | actuator controls a | problems | materials for both | |
| | catch, which prevents | | the actuator and the | |
| | the ink pusher from | | ink pusher | |
| | moving when a drop is | | Complex | |
| | not to be ejected. | | construction | |

AUXILIARY MECHANISM (APPLIED TO ALL NOZZLES)

| | | | | |
|---|---|---|---|---|
| None | The actuator directly | Simplicity of | Drop ejection | Most ink jets, |
| | fires the ink drop, and | construction | energy must be | including |
| | there is no external | Simplicity of | supplied by | piezoelectric and |
| | field or other | operation | individual nozzle | thermal bubble. |
| | mechanism required. | Small physical size | actuator | IJ01, IJ02, IJ03, |
| | | | | IJ04, IJ05, IJ07, |
| | | | | IJ09, IJ11, IJ12, |
| | | | | IJ14, IJ20, IJ22, |
| | | | | IJ23, IJ24, IJ25, |
| | | | | IJ26, IJ27, IJ28, |
| | | | | IJ29, IJ30, IJ31, |
| | | | | IJ32, IJ33, IJ34, |
| | | | | IJ35, IJ36, IJ37, |
| | | | | IJ38, IJ39, IJ40, |
| | | | | IJ41, IJ42, IJ43, |
| | | | | IJ44 |
| Oscillating | The ink pressure | Oscillating ink | Requires external | Silverbrook, EP |
| ink pressure | oscillates, providing | pressure can provide | ink pressure | 0771 658 A2 and |
| (including | much of the drop | a refill pulse, | oscillator | related patent |
| acoustic | ejection energy. The | allowing higher | Ink pressure phase | applications |
| stimulation) | actuator selects which | operating speed | and amplitude must | IJ08, IJ13, IJ15, |
| | drops are to be fired | The actuators may | be carefully | IJ17, IJ18, IJ19, |
| | by selectively | operate with much | controlled | IJ21 |
| | blocking or enabling | lower energy | Acoustic reflections | |
| | nozzles. The ink | Acoustic lenses can | in the ink chamber | |
| | pressure oscillation | be used to focus the | must be designed | |
| | may be achieved by | sound on the | for | |
| | vibrating the print | nozzles | | |
| | head, or preferably by | | | |
| | an actuator in the ink | | | |
| | supply. | | | |
| Media | The print head is | Low power | Precision assembly | Silverbrook, EP |
| proximity | placed in close | High accuracy | required | 0771 658 A2 and |
| | proximity to the print | Simple print head | Paper fibers may | related patent |
| | medium. Selected | construction | cause problems | applications |
| | drops protrude from | | Cannot print on | |
| | the print head further | | rough substrates | |
| | than unselected drops, | | | |
| | and contact the print | | | |
| | medium. The drop | | | |
| | soaks into the medium | | | |
| | fast enough to cause | | | |
| | drop separation. | | | |
| Transfer | Drops are printed to a | High accuracy | Bulky | Silverbrook, EP |
| roller | transfer roller instead | Wide range of print | Expensive | 0771 658 A2 and |
| | of straight to the print | substrates can be | Complex | related patent |
| | medium. A transfer | used | construction | applications |
| | roller can also be used | Ink can be dried on | | Tektronix hot melt |
| | for proximity drop | the transfer roller | | piezoelectric ink jet |
| | separation. | | | Any of the IJ series |
| Electrostatic | An electric field is | Low power | Field strength | Silverbrook, EP |
| | used to accelerate | Simple print head | required for | 0771 658 A2 and |
| | selected drops towards | construction | separation of small | related patent |
| | the print medium. | | drops is near or | applications |
| | | | above air | Tone-Jet |
| | | | breakdown | |
| Direct | A magnetic field is | Low power | Requires magnetic | Silverbrook, EP |
| magnetic | used to accelerate | Simple print head | ink | 0771 658 A2 and |
| field | selected drops of | construction | Requires strong | related patent |
| | magnetic ink towards | | magnetic field | applications |
| | the print medium. | | | |
| Cross | The print head is | Does not require | Requires external | IJ06, IJ16 |
| magnetic | placed in a constant | magnetic materials | magnet | |
| field | magnetic field. The | to be integrated in | Current densities | |
| | Lorenz force in a | the print head | may be high, | |
| | current carrying wire | manufacturing | resulting in | |
| | is used to move the | process | electromigration | |
| | actuator. | | problems | |
| Pulsed | A pulsed magnetic | Very low power | Complex print head | IJ10 |
| magnetic | field is used to | operation is possible | construction | |
| field | cyclically attract a | Small print head | Magnetic materials | |
| | paddle, which pushes | size | required in print | |
| | on the ink. A small | | head | |
| | actuator moves a | | | |
| | catch, which | | | |
| | selectively prevents | | | |
| | the paddle from | | | |
| | moving. | | | |

ACTUATOR AMPLIFICATION OR MODIFICATION METHOD

| | | | | |
|---|---|---|---|---|
| None | No actuator | Operational | Many actuator | Thermal Bubble Ink |
| | mechanical | simplicity | mechanisms have | jet |
| | amplification is used. | | insufficient travel, | IJ01, IJ02, IJ06, |
| | The actuator directly | | or insufficient force, | IJ07, IJ16, IJ25, |
| | drives the drop | | to efficiently drive | IJ26 |
| | ejection process. | | the drop ejection | |
| | | | process | |
| Differential | An actuator material | Provides greater | High stresses are | Piezoelectric |
| expansion | expands more on one | travel in a reduced | involved | IJ03, IJ09, IJ17, |
| bend | side than on the other. | print head area | Care must be taken | IJ18, IJ19, IJ20, |
| actuator | The expansion may be | | that the materials do | IJ21, IJ22, IJ23, |
| | thermal, piezoelectric, | | not delaminate | IJ24, IJ27, IJ29, |
| | magnetostrictive, or | | Residual bend | IJ30, IJ31, IJ32, |
| | other mechanism. The | | resulting from high | IJ33, IJ34, IJ35, |
| | bend actuator converts | | temperature or high | IJ36, IJ37, IJ38, |
| | a high force low travel | | stress during | IJ39, IJ42, IJ43, |
| | actuator mechanism to | | formation | IJ44 |
| | high travel, lower | | | |
| | force mechanism. | | | |
| Transient | A trilayer bend | Very good | High stresses are | IJ40, IJ41 |
| bend | actuator where the two | temperature stability | involved | |
| actuator | outside layers are | High speed, as a | Care must be taken | |
| | identical. This cancels | new drop can be | that the materials do | |
| | bend due to ambient | fired before heat | not delaminate | |
| | temperature and | dissipates | | |
| | residual stress. The | Cancels residual | | |
| | actuator only responds | stress of formation | | |
| | to transient heating of | | | |
| | one side or the other. | | | |
| Reverse | The actuator loads a | Better coupling to | Fabrication | IJ05, IJ11 |
| spring | spring. When the | the ink | complexity | |
| | actuator is turned off, | | High stress in the | |
| | the spring releases. | | spring | |
| | This can reverse the | | | |
| | force/distance curve of | | | |
| | the actuator to make it | | | |
| | compatible with the | | | |
| | force/time | | | |
| | requirements of the | | | |
| | drop ejection. | | | |
| Actuator | A series of thin | Increased travel | Increased | Some piezoelectric |
| stack | actuators are stacked. | Reduced drive | fabrication | ink jets |
| | This can be | voltage | complexity | IJ04 |
| | appropriate where | | Increased possibility | |
| | actuators require high | | of short circuits due | |
| | electric field strength, | | to pinholes | |
| | such as electrostatic | | | |
| | and piezoelectric | | | |
| | actuators. | | | |
| Multiple | Multiple smaller | Increases the force | Actuator forces may | IJ12, IJ13, IJ18, |
| actuators | actuators are used | available from an | not add linearly, | IJ20, IJ22, IJ28, |
| | simultaneously to | actuator | reducing efficiency | IJ42, IJ43 |
| | move the ink. Each | Multiple actuators | | |
| | actuator need provide | can be positioned to | | |
| | only a portion of the | control ink flow | | |
| | force required. | accurately | | |
| Linear | A linear spring is used | Matches low travel | Requires print head | IJ15 |
| Spring | to transform a motion | actuator with higher | area for the spring | |
| | with small travel and | travel requirements | | |
| | high force into a | Non-contact method | | |
| | longer travel, lower | of motion | | |
| | force motion. | transformation | | |
| Coiled | A bend actuator is | Increases travel | Generally restricted | IJ17, IJ21, IJ34, |
| actuator | coiled to provide | Reduces chip area | to planar | IJ35 |
| | greater travel in a | Planar | implementations | |
| | reduced chip area. | implementations are | due to extreme | |
| | | relatively easy to | fabrication difficulty | |
| | | fabricate. | in other orientations. | |
| Flexure | A bend actuator has a | Simple means of | Care must be taken | IJ10, IJ19, IJ33 |
| bend | small region near the | increasing travel of | not to exceed the | |
| actuator | fixture point, which | a bend actuator | elastic limit in the | |
| | flexes much more | | flexure area | |
| | readily than the | | Stress distribution is | |
| | remainder of the | | very uneven | |
| | actuator. The actuator | | Difficult to | |
| | flexing is effectively | | accurately model | |
| | converted from an | | with finite element | |
| | even coiling to an | | analysis | |
| | angular bend, resulting | | | |
| | in greater travel of the | | | |
| | actuator tip. | | | |
| Catch | The actuator controls a | Very low actuator | Complex | IJ10 |
| | small catch. The catch | energy | construction | |
| | either enables or | Very small actuator | Requires external | |
| | disables movement of | size | force | |
| | an ink pusher that is | | Unsuitable for | |
| | controlled in a bulk | | pigmented inks | |
| | manner. | | | |
| Gears | Gears can be used to | Low force, low | Moving parts are | IJ13 |
| | increase travel at the | travel actuators can | required | |
| | expense of duration. | be used | Several actuator | |
| | Circular gears, rack | Can be fabricated | cycles are required | |
| | and pinion, ratchets, | using standard | More complex drive | |
| | and other gearing | surface MEMS | electronics | |
| | methods can be used. | processes | Complex | |
| | | | construction | |
| | | | Friction, friction, | |
| | | | and wear are | |
| | | | possible | |
| Buckle plate | A buckle plate can be | Very fast movement | Must stay within | S. Hirata et al, “An |
| | used to change a slow | achievable | elastic limits of the | Ink-jet Head Using |
| | actuator into a fast | | materials for long | Diaphragm |
| | motion. It can also | | device life | Microactuator”, |
| | convert a high force, | | High stresses | Proc. IEEE MEMS, |
| | low travel actuator | | involved | Feb. 1996, pp 418-423. |
| | into a high travel, | | Generally high | IJ18, IJ27 |
| | medium force motion. | | power requirement | |
| Tapered | A tapered magnetic | Linearizes the | Complex | IJ14 |
| magnetic | pole can increase | magnetic | construction | |
| pole | travel at the expense | force/distance curve | | |
| | of force. | | | |
| Lever | A lever and fulcrum is | Matches low travel | High stress around | IJ32, IJ36, IJ37 |
| | used to transform a | actuator with higher | the fulcrum | |
| | motion with small | travel requirements | | |
| | travel and high force | Fulcrum area has no | | |
| | into a motion with | linear movement, | | |
| | longer travel and | and can be used for | | |
| | lower force. The lever | a fluid seal | | |
| | can also reverse the | | | |
| | direction of travel. | | | |
| Rotary | The actuator is | High mechanical | Complex | IJ28 |
| impeller | connected to a rotary | advantage | construction | |
| | impeller. A small | The ratio of force to | Unsuitable for | |
| | angular deflection of | travel of the actuator | pigmented inks | |
| | the actuator results in | can be matched to | | |
| | a rotation of the | the nozzle | | |
| | impeller vanes, which | requirements by | | |
| | push the ink against | varying the number | | |
| | stationary vanes and | of impeller vanes | | |
| | out of the nozzle. | | | |
| Acoustic | A refractive or | No moving parts | Large area required | 1993 Hadimioglu et |
| lens | diffractive (e.g. zone | | Only relevant for | al, EUP 550,192 |
| | plate) acoustic lens is | | acoustic ink jets | 1993 Elrod et al, |
| | used to concentrate | | | EUP 572,220 |
| | sound waves. | | | |
| Sharp | A sharp point is used | Simple construction | Difficult to fabricate | Tone-jet |
| conductive | to concentrate an | | using standard VLSI | |
| point | electrostatic field. | | processes for a | |
| | | | surface ejecting ink- | |
| | | | jet | |
| | | | Only relevant for | |
| | | | electrostatic ink jets | |

ACTUATOR MOTION

| | | | | |
|---|---|---|---|---|
| Volume | The volume of the | Simple construction | High energy is | Hewlett-Packard |
| expansion | actuator changes, | in the case of | typically required to | Thermal Ink jet |
| | pushing the ink in all | thermal ink jet | achieve volume | Canon Bubblejet |
| | directions. | | expansion. This | |
| | | | leads to thermal | |
| | | | stress, cavitation, | |
| | | | and kogation in | |
| | | | thermal ink jet | |
| | | | implementations | |
| Linear, | The actuator moves in | Efficient coupling to | High fabrication | IJ01, IJ02, IJ04, |
| normal to | a direction normal to | ink drops ejected | complexity may be | IJ07, IJ11, IJ14 |
| chip surface | the print head surface. | normal to the | required to achieve | |
| | The nozzle is typically | surface | perpendicular | |
| | in the line of | | motion | |
| | movement. | | | |
| Parallel to | The actuator moves | Suitable for planar | Fabrication | IJ12, IJ13, IJ15, |
| chip surface | parallel to the print | fabrication | complexity | IJ33, IJ34, IJ35, |
| | head surface. Drop | | Friction | IJ36 |
| | ejection may still be | | Stiction | |
| | normal to the surface. | | | |
| Membrane | An actuator with a | The effective area of | Fabrication | 1982 Howkins USP |
| push | high force but small | the actuator | complexity | 4,459,601 |
| | area is used to push a | becomes the | Actuator size | |
| | stiff membrane that is | membrane area | Difficulty of | |
| | in contact with the ink. | | integration in a | |
| | | | VLSI process | |
| Rotary | The actuator causes | Rotary levers may | Device complexity | IJ05, IJ08, IJ13, |
| | the rotation of some | be used to increase | May have friction at | IJ28 |
| | element, such a grill or | travel | a pivot point | |
| | impeller | Small chip area | | |
| | | requirements | | |
| Bend | The actuator bends | A very small change | Requires the | 1970 Kyser et al |
| | when energized. This | in dimensions can | actuator to be made | USP 3,946,398 |
| | may be due to | be converted to a | from at least two | 1973 Stemme USP |
| | differential thermal | large motion. | distinct layers, or to | 3,747,120 |
| | expansion, | | have a thermal | IJ03, IJ09, IJ10, |
| | piezoelectric | | difference across the | IJ19, IJ23, IJ24, |
| | expansion, | | actuator | IJ25, IJ29, IJ30, |
| | magnetostriction, or | | | IJ31, IJ33, IJ34, |
| | other form of relative | | | IJ35 |
| | dimensional change. | | | |
| Swivel | The actuator swivels | Allows operation | Inefficient coupling | IJ06 |
| | around a central pivot. | where the net linear | to the ink motion | |
| | This motion is suitable | force on the paddle | | |
| | where there are | is zero | | |
| | opposite forces | Small chip area | | |
| | applied to opposite | requirements | | |
| | sides of the paddle, | | | |
| | e.g. Lorenz force. | | | |
| Straighten | The actuator is | Can be used with | Requires careful | IJ26, IJ32 |
| | normally bent, and | shape memory | balance of stresses | |
| | straightens when | alloys where the | to ensure that the | |
| | energized. | austenic phase is | quiescent bend is | |
| | | planar | accurate | |
| Double | The actuator bends in | One actuator can be | Difficult to make | IJ36, IJ37, IJ38 |
| bend | one direction when | used to power two | the drops ejected by | |
| | one element is | nozzles. | both bend directions | |
| | energized, and bends | Reduced chip size. | identical. | |
| | the other way when | Not sensitive to | A small efficiency | |
| | another element is | ambient temperature | loss compared to | |
| | energized. | | equivalent single | |
| | | | bend actuators. | |
| Shear | Energizing the | Can increase the | Not readily | 1985 Fishbeck USP |
| | actuator causes a shear | effective travel of | applicable to other | 4,584,590 |
| | motion in the actuator | piezoelectric | actuator | |
| | material. | actuators | mechanisms | |
| Radial constriction | The actuator squeezes | Relatively easy to | High force required | 1970 Zoltan USP |
| | an ink reservoir, | fabricate single | Inefficient | 3,683,212 |
| | forcing ink from a | nozzles from glass | Difficult to integrate | |
| | constricted nozzle. | tubing as | with VLSI | |
| | | macroscopic | processes | |
| | | structures | | |
| Coil/uncoil | A coiled actuator | Easy to fabricate as | Difficult to fabricate | IJ17, IJ21, IJ34, |
| | uncoils or coils more | a planar VLSI | for non-planar | IJ35 |
| | tightly. The motion of | process | devices | |
| | the free end of the | Small area required, | Poor out-of-plane | |
| | actuator ejects the ink. | therefore low cost | stiffness | |
| Bow | The actuator bows (or | Can increase the | Maximum travel is | IJ16, IJ18, IJ27 |
| | buckles) in the middle | speed of travel | constrained | |
| | when energized. | Mechanically rigid | High force required | |
| Push-Pull | Two actuators control | The structure is | Not readily suitable | IJ18 |
| | a shutter. One actuator | pinned at both ends, | for ink jets which | |
| | pulls the shutter, and | so has a high out-of- | directly push the ink | |
| | the other pushes it. | plane rigidity | | |
| Curl | A set of actuators curl | Good fluid flow to | Design complexity | IJ20, IJ42 |
| inwards | inwards to reduce the | the region behind | | |
| | volume of ink that | the actuator | | |
| | they enclose. | increases efficiency | | |
| Curl | A set of actuators curl | Relatively simple | Relatively large | IJ43 |
| outwards | outwards, pressurizing | construction | chip area | |
| | ink in a chamber | | | |
| | surrounding the | | | |
| | actuators, and | | | |
| | expelling ink from a | | | |
| | nozzle in the chamber. | | | |
| Iris | Multiple vanes enclose | High efficiency | High fabrication | IJ22 |
| | a volume of ink. These | Small chip area | complexity | |
| | simultaneously rotate, | | Not suitable for | |
| | reducing the volume | | pigmented inks | |
| | between the vanes. | | | |
| Acoustic | The actuator vibrates | The actuator can be | Large area required | 1993 Hadimioglu et |
| vibration | at a high frequency. | physically distant | for efficient | al, EUP 550,192 |
| | | from the ink | operation at useful | 1993 Elrod et al, |
| | | | frequencies | EUP 572,220 |
| | | | Acoustic coupling | |
| | | | and crosstalk | |
| | | | Complex drive | |
| | | | circuitry | |
| | | | Poor control of drop | |
| | | | volume and position | |
| None | In various ink jet | No moving parts | Various other | Silverbrook, EP |
| | designs the actuator | | tradeoffs are | 0771 658 A2 and |
| | does not move. | | required to | related patent |
| | | | eliminate moving | applications |
| | | | parts | Tone-jet |

NOZZLE REFILL METHOD

| | | | | |
|---|---|---|---|---|
| Surface | This is the normal way | Fabrication | Low speed | Thermal ink jet |
| tension | that ink jets are | simplicity | Surface tension | Piezoelectric ink jet |
| | refilled. After the | Operational | force relatively | IJ01-IJ07, IJ10-IJ14, |
| | actuator is energized, | simplicity | small compared to | IJ16, IJ20, IJ22-IJ45 |
| | it typically returns | | actuator force | |
| | rapidly to its normal | | Long refill time | |
| | position. This rapid | | usually dominates | |
| | return sucks in air | | the total repetition | |
| | through the nozzle | | rate | |
| | opening. The ink | | | |
| | surface tension at the | | | |
| | nozzle then exerts a | | | |
| | small force restoring | | | |
| | the meniscus to a | | | |
| | minimum area. This | | | |
| | force refills the nozzle. | | | |
| Shuttered | Ink to the nozzle | High speed | Requires common | IJ08, IJ13, IJ15, |
| oscillating | chamber is provided at | Low actuator | ink pressure | IJ17, IJ18, IJ19, |
| ink pressure | a pressure that | energy, as the | oscillator | IJ21 |
| | oscillates at twice the | actuator need only | May not be suitable | |
| | drop ejection | open or close the | for pigmented inks | |
| | frequency. When a | shutter, instead of | | |
| | drop is to be ejected, | ejecting the ink drop | | |
| | the shutter is opened | | | |
| | for 3 half cycles: drop | | | |
| | ejection, actuator | | | |
| | return, and refill. The | | | |
| | shutter is then closed | | | |
| | to prevent the nozzle | | | |
| | chamber emptying | | | |
| | during the next | | | |
| | negative pressure | | | |
| | cycle. | | | |
| Refill | After the main | High speed, as the | Requires two | IJ09 |
| actuator | actuator has ejected a | nozzle is actively | independent | |
| | drop a second (refill) | refilled | actuators per nozzle | |
| | actuator is energized. | | | |
| | The refill actuator | | | |
| | pushes ink into the | | | |
| | nozzle chamber. The | | | |
| | refill actuator returns | | | |
| | slowly, to prevent its | | | |
| | return from emptying | | | |
| | the chamber again. | | | |
| Positive ink | The ink is held a slight | High refill rate, | Surface spill must | Silverbrook, EP |
| pressure | positive pressure. | therefore a high | be prevented | 0771 658 A2 and |
| | After the ink drop is | drop repetition rate | Highly hydrophobic | related patent |
| | ejected, the nozzle | is possible | print head surfaces | applications |
| | chamber fills quickly | | are required | Alternative for:, |
| | as surface tension and | | | IJ01-IJ07, IJ10-IJ14, |
| | ink pressure both | | | IJ16, IJ20, IJ22-IJ45 |
| | operate to refill the | | | |
| | nozzle. | | | |

METHOD OF RESTRICTING BACK-FLOW THROUGH INLET

| | | | | |
|---|---|---|---|---|
| Long inlet | The ink inlet channel | Design simplicity | Restricts refill rate | Thermal ink jet |
| channel | to the nozzle chamber | Operational | May result in a | Piezoelectric ink jet |
| | is made long and | simplicity | relatively large chip | IJ42, IJ43 |
| | relatively narrow, | Reduces crosstalk | area | |
| | relying on viscous | | Only partially | |
| | drag to reduce inlet | | effective | |
| | back-flow. | | | |
| Positive ink | The ink is under a | Drop selection and | Requires a method | Silverbrook, EP |
| pressure | positive pressure, so | separation forces | (such as a nozzle | 0771 658 A2 and |
| | that in the quiescent | can be reduced | rim or effective | related patent |
| | state some of the ink | Fast refill time | hydrophobizing, or | applications |
| | drop already protrudes | | both) to prevent | Possible operation |
| | from the nozzle. | | flooding of the | of the following: |
| | This reduces the | | ejection surface of | IJ01-IJ07, IJ09-IJ12, |
| | pressure in the nozzle | | the print head. | IJ14, IJ16, |
| | chamber which is | | | IJ20, IJ22, IJ23-IJ34, |
| | required to eject a | | | IJ36-IJ41, |
| | certain volume of ink. | | | IJ44 |
| | The reduction in | | | |
| | chamber pressure | | | |
| | results in a reduction | | | |
| | in ink pushed out | | | |
| | through the inlet. | | | |
| Baffle | One or more baffles | The refill rate is not | Design complexity | HP Thermal Ink Jet |
| | are placed in the inlet | as restricted as the | May increase | Tektronix |
| | ink flow. When the | long inlet method. | fabrication | piezoelectric ink jet |
| | actuator is energized, | Reduces crosstalk | complexity (e.g. | |
| | the rapid ink | | Tektronix hot melt | |
| | movement creates | | Piezoelectric print | |
| | eddies which restrict | | heads). | |
| | the flow through the | | | |
| | inlet. The slower refill | | | |
| | process is unrestricted, | | | |
| | and does not result in | | | |
| | eddies. | | | |
| Flexible flap | In this method recently | Significantly | Not applicable to | Canon |
| restricts | disclosed by Canon, | reduces back-flow | most ink jet | |
| inlet | the expanding actuator | for edge-shooter | configurations | |
| | (bubble) pushes on a | thermal ink jet | Increased | |
| | flexible flap that | devices | fabrication | |
| | restricts the inlet. | | complexity | |
| | | | Inelastic | |
| | | | deformation of | |
| | | | polymer flap results | |
| | | | in creep over | |
| | | | extended use | |
| Inlet filter | A filter is located | Additional | Restricts refill rate | IJ04, IJ12, IJ24, |
| | between the ink inlet | advantage of ink | May result in | IJ27, IJ29, IJ30 |
| | and the nozzle | filtration | complex | |
| | chamber. The filter | Ink filter may be | construction | |
| | has a multitude of | fabricated with no | | |
| | small holes or slots, | additional process | | |
| | restricting ink flow. | steps | | |
| | The filter also removes | | | |
| | particles which may | | | |
| | block the nozzle. | | | |
| Small inlet | The ink inlet channel | Design simplicity | Restricts refill rate | IJ02, IJ37, IJ44 |
| compared | to the nozzle chamber | | May result in a | |
| to nozzle | has a substantially | | relatively large chip | |
| | smaller cross section | | area | |
| | than that of the nozzle, | | Only partially | |
| | resulting in easier ink | | effective | |
| | egress out of the | | | |
| | nozzle than out of the | | | |
| | inlet. | | | |
| Inlet shutter | A secondary actuator | Increases speed of | Requires separate | IJ09 |
| | controls the position of | the ink-jet print | refill actuator and | |
| | a shutter, closing off | head operation | drive circuit | |
| | the ink inlet when the | | | |
| | main actuator is | | | |
| | energized. | | | |
| The inlet is | The method avoids the | Back-flow problem | Requires careful | IJ01, IJ03, 1J05, |
| located | problem of inlet back- | is eliminated | design to minimize | IJ06, IJ07, IJ10, |
| behind the | flow by arranging the | | the negative | IJ11, IJ14, IJ16, |
| ink-pushing | ink-pushing surface of | | pressure behind the | IJ22, IJ23, IJ25, |
| surface | the actuator between | | paddle | IJ28, IJ31, IJ32, |
| | the inlet and the | | | IJ33, IJ34, IJ35, |
| | nozzle. | | | IJ36, IJ39, IJ40, |
| | | | | IJ41 |
| Part of the | The actuator and a | Significant | Small increase in | IJ07, IJ20, IJ26, |
| actuator | wall of the ink | reductions in back- | fabrication | IJ38 |
| moves to | chamber are arranged | flow can be | complexity | |
| shut off the | so that the motion of | achieved | | |
| inlet | the actuator closes off | Compact designs | | |
| | the inlet. | possible | | |
| Nozzle | In some configurations | Ink back-flow | None related to ink | Silverbrook, EP |
| actuator | of ink jet, there is no | problem is | back-flow on | 0771 658 A2 and |
| does not | expansion or | eliminated | actuation | related patent |
| result in ink | movement of an | | | applications |
| back-flow | actuator which may | | | Valve-jet |
| | cause ink back-flow | | | Tone-jet |
| | through the inlet. | | | |

NOZZLE CLEARING METHOD

| | | | | |
|---|---|---|---|---|
| Normal | All of the nozzles are | No added | May not be | Most ink jet systems |
| nozzle firing | fired periodically, | complexity on the | sufficient to | IJ01, IJ02, IJ03, |
| | before the ink has a | print head | displace dried ink | IJ04, IJ05, IJ06, |
| | chance to dry. When | | | IJ07, IJ09, IJ10, |
| | not in use the nozzles | | | IJ11, IJ12, IJ14, |
| | are sealed (capped) | | | IJ16, IJ20, IJ22, |
| | against air. | | | IJ23, IJ24, IJ25, |
| | The nozzle firing is | | | IJ26, IJ27, IJ28, |
| | usually performed | | | IJ29, IJ30, IJ31, |
| | during a special | | | IJ32, IJ33, IJ34, |
| | clearing cycle, after | | | IJ36, IJ37, IJ38, |
| | first moving the print | | | IJ39, IJ40, IJ41, |
| | head to a cleaning | | | IJ42, IJ43, IJ44,, |
| | station. | | | IJ45 |
| Extra | In systems which heat | Can be highly | Requires higher | Silverbrook, EP |
| power to | the ink, but do not boil | effective if the | drive voltage for | 0771 658 A2 and |
| ink heater | it under normal | heater is adjacent to | clearing | related patent |
| | situations, nozzle | the nozzle | May require larger | applications |
| | clearing can be | | drive transistors | |
| | achieved by over- | | | |
| | powering the heater | | | |
| | and boiling ink at the | | | |
| | nozzle. | | | |
| Rapid | The actuator is fired in | Does not require | Effectiveness | May be used with: |
| success-ion | rapid succession. In | extra drive circuits | depends | IJ01, IJ02, IJ03, |
| of actuator | some configurations, | on the print head | substantially upon | IJ04, IJ05, IJ06, |
| pulses | this may cause heat | Can be readily | the configuration of | IJ07, IJ09, IJ10, |
| | build-up at the nozzle | controlled and | the ink jet nozzle | IJ11, IJ14, IJ16, |
| | which boils the ink, | initiated by digital | | IJ20, IJ22, IJ23, |
| | clearing the nozzle. In | logic | | IJ24, IJ25, IJ27, |
| | other situations, it may | | | IJ28, IJ29, IJ30, |
| | cause sufficient | | | IJ31, IJ32, IJ33, |
| | vibrations to dislodge | | | IJ34, IJ36, IJ37, |
| | clogged nozzles. | | | IJ38, IJ39, IJ40, |
| | | | | IJ41, IJ42, IJ43, |
| | | | | IJ44, IJ45 |
| Extra | Where an actuator is | A simple solution | Not suitable where | May be used with: |
| power to | not normally driven to | where applicable | there is a hard limit | IJ03, IJ09, IJ16, |
| ink pushing | the limit of its motion, | | to actuator | IJ20, IJ23, IJ24, |
| actuator | nozzle clearing may be | | movement | IJ25, IJ27, IJ29, |
| | assisted by providing | | | IJ30, IJ31, IJ32, |
| | an enhanced drive | | | IJ39, IJ40, IJ41, |
| | signal to the actuator. | | | IJ42, IJ43, IJ44, |
| | | | | IJ45 |
| Acoustic | An ultrasonic wave is | A high nozzle | High | IJ08, IJ13, IJ15, |
| resonance | applied to the ink | clearing capability | implementation cost | IJ17, IJ18, IJ19, |
| | chamber. This wave is | can be achieved | if system does not | IJ21 |
| | of an appropriate | May be | already include an | |
| | amplitude and | implemented at very | acoustic actuator | |
| | frequency to cause | low cost in systems | | |
| | sufficient force at the | which already | | |
| | nozzle to clear | include acoustic | | |
| | blockages. This is | actuators | | |
| | easiest to achieve if | | | |
| | the ultrasonic wave is | | | |
| | at a resonant | | | |
| | frequency of the ink | | | |
| | cavity. | | | |
| Nozzle | A microfabricated | Can clear severely | Accurate | Silverbrook, EP |
| clearing | plate is pushed against | clogged nozzles | mechanical | 0771 658 A2 and |
| plate | the nozzles. The plate | | alignment is | related patent |
| | has a post for every | | required | applications |
| | nozzle. A post moves | | Moving parts are | |
| | through each nozzle, | | required | |
| | displacing dried ink. | | There is risk of | |
| | | | damage to the | |
| | | | nozzles | |
| | | | Accurate fabrication | |
| | | | is required | |
| Ink | The pressure of the ink | May be effective | Requires pressure | May be used with |
| pressure | is temporarily | where other | pump or other | all IJ series ink jets |
| pulse | increased so that ink | methods cannot be | pressure actuator | |
| | streams from all of the | used | Expensive | |
| | nozzles. This may be | | Wasteful of ink | |
| | used in conjunction | | | |
| | with actuator | | | |
| | energizing. | | | |
| Print head | A flexible ‘blade’ is | Effective for planar | Difficult to use if | Many ink jet |
| wiper | wiped across the print | print head surfaces | print head surface is | systems |
| | head surface. The | Low cost | non-planar or very | |
| | blade is usually | | fragile | |
| | fabricated from a | | Requires | |
| | flexible polymer, e.g. | | mechanical parts | |
| | rubber or synthetic | | Blade can wear out | |
| | elastomer. | | in high volume print | |
| | | | systems | |
| Separate | A separate heater is | Can be effective | Fabrication | Can be used with |
| ink boiling | provided at the nozzle | where other nozzle | complexity | many IJ series ink |
| heater | although the normal | clearing methods | | jets |
| | drop ejection | cannot be used | | |
| | mechanism does not | Can be implemented | | |
| | require it. The heaters | at no additional cost | | |
| | do not require | in some ink jet | | |
| | individual drive | configurations | | |
| | circuits, as many | | | |
| | nozzles can be cleared | | | |
| | simultaneously, and no | | | |
| | imaging is required. | | | |

NOZZLE PLATE CONSTRUCTION

| | | | | |
|---|---|---|---|---|
| Electroformed | A nozzle plate is | Fabrication | High temperatures | Hewlett Packard |
| nickel | separately fabricated | simplicity | and pressures are | Thermal Ink jet |
| | from electroformed | | required to bond | |
| | nickel, and bonded to | | nozzle plate | |
| | the print head chip. | | Minimum thickness | |
| | | | constraints | |
| | | | Differential thermal | |
| | | | expansion | |
| Laser | Individual nozzle | No masks required | Each hole must be | Canon Bubblejet |
| ablated or | holes are ablated by an | Can be quite fast | individually formed | 1988 Sercel et al., |
| drilled | intense UV laser in a | Some control over | Special equipment | SPIE, Vol. 998 |
| polymer | nozzle plate, which is | nozzle profile is | required | Excimer Beam |
| | typically a polymer | possible | Slow where there | Applications, pp. |
| | such as polyimide or | Equipment required | are many thousands | 76-83 |
| | polysulphone | is relatively low cost | of nozzles per print | 1993 Watanabe et |
| | | | head | al., USP 5,208,604 |
| | | | May produce thin | |
| | | | burrs at exit holes | |
| Silicon | A separate nozzle | High accuracy is | Two part | K. Bean, IEEE |
| micromachined | plate is | attainable | construction | Transactions on |
| | micromachined from | | High cost | Electron Devices, |
| | single crystal silicon, | | Requires precision | Vol. ED-25, No. 10, |
| | and bonded to the | | alignment | 1978, pp 1185-1195 |
| | print head wafer. | | Nozzles may be | Xerox 1990 |
| | | | clogged by adhesive | Hawkins et al., USP |
| | | | | 4,899,181 |
| Glass | Fine glass capillaries | No expensive | Very small nozzle | 1970 Zoltan USP |
| capillaries | are drawn from glass | equipment required | sizes are difficult to | 3,683,212 |
| | tubing. This method | Simple to make | form | |
| | has been used for | single nozzles | Not suited for mass | |
| | making individual | | production | |
| | nozzles, but is difficult | | | |
| | to use for bulk | | | |
| | manufacturing of print | | | |
| | heads with thousands | | | |
| | of nozzles. | | | |
| Monolithic, | The nozzle plate is | High accuracy (<1 | Requires sacrificial | Silverbrook, EP |
| surface | deposited as a layer | μm) | layer under the | 0771 658 A2 and |
| micromachined | using standard VLSI | Monolithic | nozzle plate to form | related patent |
| using VLSI | deposition techniques. | Low cost | the nozzle chamber | applications |
| lithographic | Nozzles are etched in | Existing processes | Surface may be | IJ01, IJ02, IJ04, |
| processes | the nozzle plate using | can be used | fragile to the touch | IJ11, IJ12, IJ17, |
| | VLSI lithography and | | | IJ18, IJ20, IJ22, |
| | etching. | | | IJ24, IJ27, IJ28, |
| | | | | IJ29, IJ30, IJ31, |
| | | | | IJ32, IJ33, IJ34, |
| | | | | IJ36, IJ37, IJ38, |
| | | | | IJ39, IJ40, IJ41, |
| | | | | IJ42, IJ43, IJ44 |
| Monolithic, | The nozzle plate is a | High accuracy (<1 | Requires long etch | IJ03, IJ05, IJ06, |
| etched | buried etch stop in the | μm) | times | IJ07, IJ08, IJ09, |
| through | wafer. Nozzle | Monolithic | Requires a support | IJ10, IJ13, IJ14, |
| substrate | chambers are etched in | Low cost | wafer | IJ15, IJ16, IJ19, |
| | the front of the wafer, | No differential | | IJ21, IJ23, IJ25, |
| | and the wafer is | expansion | | IJ26 |
| | thinned from the back | | | |
| | side. Nozzles are then | | | |
| | etched in the etch stop | | | |
| | layer. | | | |
| No nozzle | Various methods have | No nozzles to | Difficult to control | Ricoh 1995 Sekiya |
| plate | been tried to eliminate | become clogged | drop position | et al USP 5,412,413 |
| | the nozzles entirely, to | | accurately | 1993 Hadimioglu et |
| | prevent nozzle | | Crosstalk problems | al EUP 550,192 |
| | clogging. These | | | 1993 Elrod et al |
| | include thermal bubble | | | EUP 572,220 |
| | mechanisms and | | | |
| | acoustic lens | | | |
| | mechanisms | | | |
| Trough | Each drop ejector has | Reduced | Drop firing | IJ35 |
| | a trough through | manufacturing | direction is sensitive | |
| | which a paddle moves. | complexity | to wicking. | |
| | There is no nozzle | Monolithic | | |
| | plate. | | | |
| Nozzle slit | The elimination of | No nozzles to | Difficult to control | 1989 Saito et al |
| instead of | nozzle holes and | become clogged | drop position | USP 4,799,068 |
| individual | replacement by a slit | | accurately | |
| nozzles | encompassing many | | Crosstalk problems | |
| | actuator positions | | | |
| | reduces nozzle | | | |
| | clogging, but increases | | | |
| | crosstalk due to ink | | | |
| | surface waves | | | |

DROP EJECTION DIRECTION

| | | | | |
|---|---|---|---|---|
| Edge | Ink flow is along the | Simple construction | Nozzles limited to | Canon Bubblejet |
| (‘edge | surface of the chip, | No silicon etching | edge | 1979 Endo et al GB |
| shooter’) | and ink drops are | required | High resolution is | patent 2,007,162 |
| | ejected from the chip | Good heat sinking | difficult | Xerox heater-in-pit |
| | edge. | via substrate | Fast color printing | 1990 Hawkins et al |
| | | Mechanically strong | requires one print | USP 4,899,181 |
| | | Ease of chip | head per color | Tone-jet |
| | | handing | | |
| Surface | Ink flow is along the | No bulk silicon | Maximum ink flow | Hewlett-Packard TIJ |
| (‘roof | surface of the chip, | etching required | is severely restricted | 1982 Vaught et al |
| shooter’) | and ink drops are | Silicon can make an | | USP 4,490,728 |
| | ejected from the chip | effective heat sink | | IJ02, IJ11, IJ12, |
| | surface, normal to the | Mechanical strength | | IJ20, IJ22 |
| | plane of the chip. | | | |
| Through | Ink flow is through the | High ink flow | Requires bulk | Silverbrook, EP |
| chip, | chip, and ink drops are | Suitable for | silicon etching | 0771 658 A2 and |
| forward | ejected from the front | pagewidth print | | related patent |
| (‘up | surface of the chip. | heads | | applications |
| shooter’) | | High nozzle packing | | IJ04, IJ17, IJ18, |
| | | density therefore | | IJ24, IJ27-1145 |
| | | low manufacturing | | |
| | | cost | | |
| Through | Ink flow is through the | High ink flow | Requires wafer | IJ01, IJ03, IJ05, |
| chip, | chip, and ink drops are | Suitable for | thinning | IJ06, IJ07, IJ08, |
| reverse | ejected from the rear | pagewidth print | Requires special | IJ09, IJ10, IJ13, |
| (‘down | surface of the chip. | heads | handling during | IJ14, IJ15, IJ16, |
| shooter’) | | High nozzle packing | manufacture | IJ19, IJ21, IJ23, |
| | | density therefore | | IJ25, IJ26 |
| | | low manufacturing | | |
| | | cost | | |
| Through | Ink flow is through the | Suitable for | Pagewidth print | Epson Stylus |
| actuator | actuator, which is not | piezoelectric print | heads require | Tektronix hot melt |
| | fabricated as part of | heads | several thousand | piezoelectric ink jets |
| | the same substrate as | | connections to drive | |
| | the drive transistors. | | circuits | |
| | | | Cannot be | |
| | | | manufactured in | |
| | | | standard CMOS | |
| | | | fabs | |
| | | | Complex assembly | |
| | | | required | |

INK TYPE

| | | | | |
|---|---|---|---|---|
| Aqueous, | Water based ink which | Environmentally | Slow drying | Most existing ink |
| dye | typically contains: | friendly | Corrosive | jets |
| | water, dye, surfactant, | No odor | Bleeds on paper | All IJ series ink jets |
| | humectant, and | | May strikethrough | Silverbrook, EP |
| | biocide. | | Cockles paper | 0771 658 A2 and |
| | Modern ink dyes have | | | related patent |
| | high water-fastness, | | | applications |
| | light fastness | | | |
| Aqueous, | Water based ink which | Environmentally | Slow drying | IJ02, IJ04, IJ21, |
| pigment | typically contains: | friendly | Corrosive | IJ26, IJ27, IJ30 |
| | water, pigment, | No odor | Pigment may clog | Silverbrook, EP |
| | surfactant, humectant, | Reduced bleed | nozzles | 0771 658 A2 and |
| | and biocide. | Reduced wicking | Pigment may clog | related patent |
| | Pigments have an | Reduced | actuator | applications |
| | advantage in reduced | strikethrough | mechanisms | Piezoelectric ink- |
| | bleed, wicking and | | Cockles paper | jets |
| | strikethrough. | | | Thermal ink jets |
| | | | | (with significant |
| | | | | restrictions) |
| Methyl | MEK is a highly | Very fast drying | Odorous | All IJ series ink jets |
| Ethyl | volatile solvent used | Prints on various | Flammable | |
| Ketone | for industrial printing | substrates such as | | |
| (MEK) | on difficult surfaces | metals and plastics | | |
| | such as aluminum | | | |
| | cans. | | | |
| Alcohol | Alcohol based inks | Fast drying | Slight odor | All IJ series ink jets |
| (ethanol, 2- | can be used where the | Operates at sub- | Flammable | |
| butanol, | printer must operate at | freezing | | |
| and others) | temperatures below | temperatures | | |
| | the freezing point of | Reduced paper | | |
| | water. An example of | cockle | | |
| | this is in-camera | Low cost | | |
| | consumer | | | |
| | photographic printing. | | | |
| Phase | The ink is solid at | No drying time-ink | High viscosity | Tektronix hot melt |
| change | room temperature, and | instantly freezes on | Printed ink typically | piezoelectric ink jets |
| (hot melt) | is melted in the print | the print medium | has a ‘waxy’ feel | 1989 Nowak USP |
| | head before jetting. | Almost any print | Printed pages may | 4,820,346 |
| | Hot melt inks are | medium can be used | ‘block’ | All IJ series ink jets |
| | usually wax based, | No paper cockle | Ink temperature | |
| | with a melting point | occurs | may be above the | |
| | around 80° C. After | No wicking occurs | curie point of | |
| | jetting the ink freezes | No bleed occurs | permanent magnets | |
| | almost instantly upon | No strikethrough | Ink heaters consume | |
| | contacting the print | occurs | power | |
| | medium or a transfer | | Long warm-up time | |
| | roller. | | | |
| Oil | Oil based inks are | High solubility | High viscosity: this | All IJ series ink jets |
| | extensively used in | medium for some | is a significant | |
| | offset printing. They | dyes | limitation for use in | |
| | have advantages in | Does not cockle | ink jets, which | |
| | improved | paper | usually require a | |
| | characteristics on | Does not wick | low viscosity. Some | |
| | paper (especially no | through paper | short chain and | |
| | wicking or cockle). | | multi-branched oils | |
| | Oil soluble dies and | | have a sufficiently | |
| | pigments are required. | | low viscosity. | |
| | | | Slow drying | |
| Microemulsion | A microemulsion is a | Stops ink bleed | Viscosity higher | All IJ series ink jets |
| | stable, self forming | High dye solubility | than water | |
| | emulsion of oil, water, | Water, oil, and | Cost is slightly | |
| | and surfactant. The | amphiphilic soluble | higher than water | |
| | characteristic drop size | dies can be used | based ink | |
| | is less than 100 nm, | Can stabilize | High surfactant | |
| | and is determined by | pigment | concentration | |
| | the preferred curvature | suspensions | required (around | |
| | of the surfactant. | | 5%) | |

We claim:

1. An ink jet printhead nozzle arrangement comprising:
a wafer substrate
an ink chamber formed therein;
an ink ejection port formed by a substantially centrally located rim on a wall of said chamber;
at least one flexible portion located on said wall; and
rib elements located on the outer surface of said wall
whereby the wall is adapted to move independently of said rim such that upon actuation the at least one flexible portion displaces and interacting with the rib elements moves said wall into said ink chamber forcing ink therein, out through the said ink ejection port.

2. The arrangement according to claim 1, wherein at least a portion of the rib elements extend radially with respect to the ink ejection port.

3. The arrangement according to claim 1 wherein the wall is configured to bend into the ink chamber away from the centre of the ink chamber.

4. The arrangement according to claim 3 wherein the said at least one flexible portion of said wall is made from material having a thermal expansion suitable to cause the wall to move into said ink chamber upon uneven heating of the at least one flexible portion of the wall.

5. The arrangement according to claim 4 wherein a heating element is located in conductive contact with each flexible portion of the wall.

6. The arrangement according to claim 5 wherein each heating element is serpentine in shape to allow for unhindered expansion of the flexible wall portion.

7. The arrangement according to claim 6 wherein each heating element is located remote from the rim of the ink ejector port.

8. The arrangement according to claim 1 wherein an ink inlet channel formed in said wafer substrate and is in communication with said ink chamber.

9. The arrangement according to claim 8 wherein the ink inlet channel enters into said ink chamber opposite the said wall.
